(19) United States
(12) Patent Application Publication
(10) Pub. No.: US 2004/0073414 A1
(43) Pub. Date: Apr. 15, 2004

(54) Method and system for inferring hand motion from multi-cell recordings in the motor cortex using a kalman filter or a bayesian model

(75) Inventors: Lucien J.E. Bienenstock, Providence, RI (US); Michael J. Black, Providence, RI (US); Wei Wu, Providence, RI (US); Yun Gao, Providence, RI (US)

Correspondence Address: HARRINGTON & SMITH, LLP, 4 RESEARCH DRIVE, SHELTON, CT, 06484-6212, US

(73) Assignee: Brown University Research Foundation

(21) Appl. No.: 10/455,509

(22) Filed: Jun. 4, 2003

Related U.S. Application Data
(60) Provisional application No. 60/385,529, filed on Jun. 4, 2002.

(51) Int. Cl. G06F 17/10

(52) U.S. Cl. 703/2

(57) ABSTRACT

A method and system to decode neural activity in the motor cortex to infer at least the position and velocity of a subject's hand from neural spiking activity of some number of nerve cells. In one embodiment the method includes simultaneously recording electrical activity of the nerve cells in the primary motor cortex to obtain neural data; and modeling the encoding and decoding of the neural data using a Kalman filter, where a measurement model assumes a cell firing rate to be a stochastic linear function of at least the position and velocity of the hand, and where the measurement model is learned from training data in conjunction with a system model that encodes a manner in which the hand moves. In another embodiment the method includes using the neural data to generate training data of neural firing activity conditioned on hand kinematics; learning a non-parametric representation of the firing activity using a Bayesian model; inferring an a posterior probability distribution over hand motion, conditioned on the neural training data using Bayesian inference; defining a non-Gaussian likelihood term that is combined with a prior probability for the kinematics based on learned firing models of multiple nerve cells; and using a particle filtering method is to represent, update, and propagate the posterior distribution over time.

### CLAIM OF PRIORITY FROM A COPENDING U.S. PROVISIONAL PATENT APPLICATION:

This patent application claims priority under 35 U.S.C. 119(e) from Provisional Patent Application No. 60/385,529, filed Jun. 4, 2002, the content of which is incorporated by reference herein in its entirety.

### TECHNICAL FIELD

This invention relates generally to methods and apparatus for recording and analyzing electrical signals generated by neurons and, more specifically, relates to the use of such signals for controlling the motion of an object in three dimensional (3D) space.

### BACKGROUND

Many mathematical algorithms have been proposed to model the encoding of hand motion by neural firing activity, and to decode this activity to recover the motion information from multi-cell recordings. For example, Georgopoulos et al., “Neural population coding of movement direction”, Science, 8(2):196-198, 1986, have used a center-out task in which the subject moved the hand from a central location to one of eight radially located targets. They suggested that the movement direction may be encoded by the neural ensemble in the arm area of motor cortex (MI), and the ensemble activity of the cells was combined using a population vector algorithm.

Based on their work, Moran and Schwartz (“Motor cortical representation of speed and direction during reaching”, J. of Neurophysiology, 82(5):2676-2692, 1999) encoded both the instantaneous speed and direction using the population vector. They showed that the activity of the cell is modulated with speed when the subject moves the arm in the preferred direction. Also they suggested that spiking activity precedes, or lags, the corresponding movement and this lag may vary between cells. This population vector approach has been used for the real-time neural control of 2D and 3D cursor movement.

While this approach appears to work well, it lacks a formal mathematical foundation and provides no estimate of uncertainty. These factors make it difficult to extend this approach to the more complex analysis of temporal movement patterns.

Traditional linear filtering has also been used for decoding (Paninski et al., “Temporal tuning properties for hand position and velocity in motor cortical neurons”, submitted, J. of Neurophysiology, 2001, Warland et al., “Decoding visual information from a population of retinal ganglion cells”, J. of Neurophysiology, 78(5): 2336-2350,1997) and can be used to achieve real-time neural control of a 2D cursor (Serruya et al. “Brainmachine interface: Instant neural control of a movement signal”, Nature, (416): 141-142, 2002). This approach requires the use of data over a long time window (typically 500 ms to 1 s). However, such a long window of temporal integration may not be appropriate for faster or more complex (higher frequency) motions. Other approaches based on Artificial Neural Networks (ANN) and principal component analysis (PCA) have similar limitations.

What is needed is a probabilistically grounded method that uses data in small time windows (e.g., 50 ms to 70 ms), and that integrates that information over time in a recursive fashion.

The Kalman filter has been widely used for estimation problems ranging from target tracking to vehicle control. It should be noted that Brown et al., “A statistical paradigm for neural spike train decoding applied to position prediction from ensemble firing patterns of rat hippocampal place cells, J. of Neuroscience, 18(18):7411-7425, 1998, proposed a Kalman filter to establish the position of a rat from the firing activity of hippocampal place cells. The Kalman filter has not, however, been heretofore used to solve the problem of decoding hand kinematics from neural activity in motor cortex.

The CONDENSATION algorithm has been recently introduced as a Bayesian decoding scheme (Gao et al., “Probabilistic inference of hand motion from neural activity in motor cortex” Advances in Neural Information Processing Systems 14, The MIT Press, 2002), which provides a probabilistic framework for causal estimation. The CONDENSATION algorithm is shown to be superior to the performance of linear filtering when sufficient data is available (e.g. firing rates for several hundred cells). It should be noted that the CONDENSATION method is more general than the Kalman filter in that it does not assume linear models and Gaussian noise. While this may be important for neural decoding, as suggested by Gao et al., current recording technology makes the method impractical for real-time control.

### SUMMARY OF THE PREFERRED EMBODIMENTS

The foregoing and other problems are overcome, and other advantages are realized, in accordance with the presently preferred embodiments of these teachings.

A first aspect of this invention is directed to providing a control-theoretic approach to the problem of decoding neural activity in the motor cortex. A goal of this aspect of the invention is to infer the position and velocity of a subject's hand from the neural spiking activity of some number of cells, e.g., from 25 cells, that are simultaneously recorded in the primary motor cortex. In the preferred embodiment a method models the encoding and decoding of the neural data using a Kalman filter. A measurement model is specified that assumes the firing rate of a cell within 50 ms is a stochastic linear function of position, velocity, and acceleration of the hand. The model is learned from training data along with a system model that encodes how the hand moves. Experimental results are provided to show that the reconstructed trajectories are superior to those obtained by conventional linear filtering. Additionally, the use of the Kalman filter provides insight into the neural encoding of hand motion. For example, analysis of the measurement model suggests that, while the neural firing is closely related to the position and velocity of the hand, the acceleration is redundant and can be ignored in the model. Furthermore, the Kalman filter framework is exploited to recover the optimal lag time between hand movement and neural firing.

In another aspect of this invention statistical learning and probabilistic inference techniques are used to infer the hand position of a subject from, as an example, multi-electrode recordings of neural activity in motor cortex. First, an array of electrodes is used to provide training data of neural firing conditioned on hand kinematics. A non-parametric representation of this firing activity is learned using a Bayesian model. Second, an a posterior probability distribution over hand motion is inferred, conditioned on a sequence of neural test data using Bayesian inference. The learned firing models of multiple cells are used to define a non-Gaussian likelihood term that is combined with a prior probability for the kinematics. A particle filtering method is employed to represent, update, and propagate the posterior distribution over time. When this approach is compared with traditional linear filtering methods; the results show that it can be appropriate for neural prosthetic applications.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 illustrates a reconstruction of 2D hand motion, where in FIG. 1A a training procedure records spiking activity while a subject tracks a target by moving a jointed manipulandum on a 2D plane; and FIG. 1B a decoding procedure shows a true target trajectory (thin line) and reconstruction using the Kalman filter (thick trace).

FIG. 2 illustrates a number of mathematical expressions referred to in the detailed description of the first embodiment of this invention.

FIG. 3 is a reconstruction of test trials, where true target trajectory is plotted using a thin line and reconstruction using the Kalman filter is plotted using a thicker line.

FIG. 4 is a reconstruction of each component of the system variable for one trial: true target trajectory (thin) and reconstruction using the Kalman filter (thick).

FIG. 5 shows the L² norm of the difference of the consecutive matrices for Pₖ, P′ₖ and Kₖ. As k increases, the norm decreases exponentially (since its logarithm decreases linearly).

FIG. 6 is a reconstruction of the test trials of FIG. 3, but using a linear filter: true target trajectory (thin) and reconstruction using the linear filter (thick).

FIG. 7 shows the maximum and mean of each column of H⁻. The position (1&2) and velocity (3&4) can be seen to have a stronger effect on the model than acceleration (5&6).

FIG. 8 shows a reconstruction using just position arid velocity: true target trajectory (thin trace) and reconstruction using the Kalman filter (thick trace).

FIG. 9 is a plot that assumes that all C=25 cells have uniform time lag, and shows the mean square error (MSE) when the lag is 0, 1, . . . or 9 time steps.

FIG. 10 shows in (a) an initial lag with uniform (dashed line) and random (solid line) initial conditions, and (b) an optimal lag from uniform initial (dashed line) and random initial (solid line) conditions.

FIG. 11A shows a multi- or micro-electrode array comprised of a 10×10 array of electrode having a separation of 400 micrometers, FIG. 11B shows an exemplary placement of the micro-electrode array on the MI arm area, FIG. 11C illustrates in cross-section the implanted micro-electrode array, and FIG. 11D shows an example of spike patterns recorded from the multi-electrode array.

FIG. 12A shows the x and y distribution of hand position, and FIG. 12B the distribution of velocity of the hand (horizontal axis represents direction, −π≦θ<π, and the vertical axis represents speed, r).

FIG. 13 shows examples of observed mean conditional firing rates in 50 ms intervals for three cells given hand velocity. The horizontal axis represents the direction of movement, θ, in radians (wrapping around −π to π), and the vertical axis represents speed, r, and ranges from 0 cm/sec to 12 cm/sec.

FIG. 14 illustrates a number of mathematical expressions referred to in the detailed description of the second embodiment of this invention.

FIG. 15 shows the prior probability of firing variation (Δg), where (a) is the probability of firing variation computed from training data and a robust prior model plotted for σ=0.28, and where (b) is the logarithm of the distributions shown to provide detail.

FIG. 16 illustrates estimated firing rates for the cells of FIG. 13 using different models.

FIG. 17 depicts a numerical comparison table for the various models of FIG. 16, and depicts the log likelihood ratio of pairs of models and the significance level given by a Wilcoxon signed rank test.

FIGS. 18A and 18B illustrate tracking results using 1008 synthetic cells showing horizontal velocity (top graphs) and vertical velocity (bottom graphs). The graphs of FIG. 18A depict the Bayesian estimate using particle filtering, while the graphs of FIG. 18B show the conventional linear filtering method.

FIGS. 19-23A, 23B, 23C and 23D are useful in explaining the operation of one of the presently preferred signal processing algorithms.

FIG. 24 is a high level diagram illustrating a neural prosthetic system.

### DETAILED DESCRIPTION OF THE PREFERRED EMBODIMENTS

Described herein with regard to the first aspect of this invention is a control-theoretic model for the encoding of bodily movement, such as hand movement, in the motor cortex and for inferring, or decoding, this movement from the firing rates of a population of cells. It is shown below that this approach has: (1) a sound probabilistic foundation; (2) explicitly models noise in the data; (3) indicates the uncertainty in estimates of hand position; (4) makes minimal assumptions about the data; (5) provides on-line estimates of hand position with short delay (e.g., less than 200 ms); and (6) provides insight into the neural coding of movement. The Kalman filtering method discussed herein provides a rigorous and well understood framework that addresses these issues. Combined with advances in multi-electrode recording in awake, behaving, subjects, the method disclosed herein is shown to be applicable to the precise neural control of external devices.

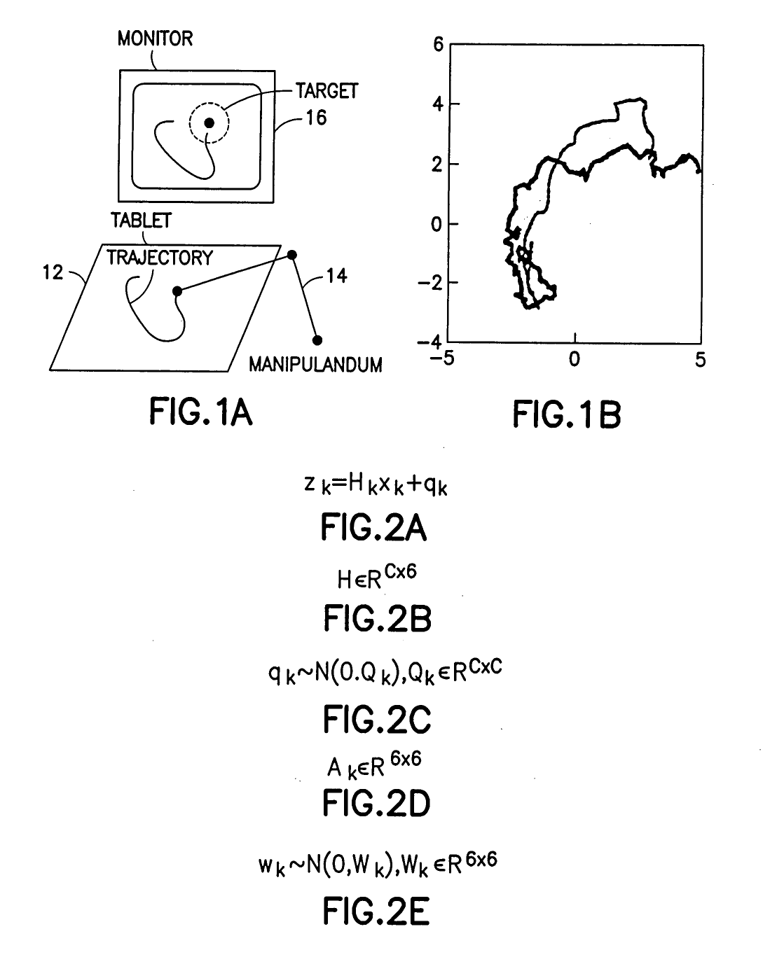

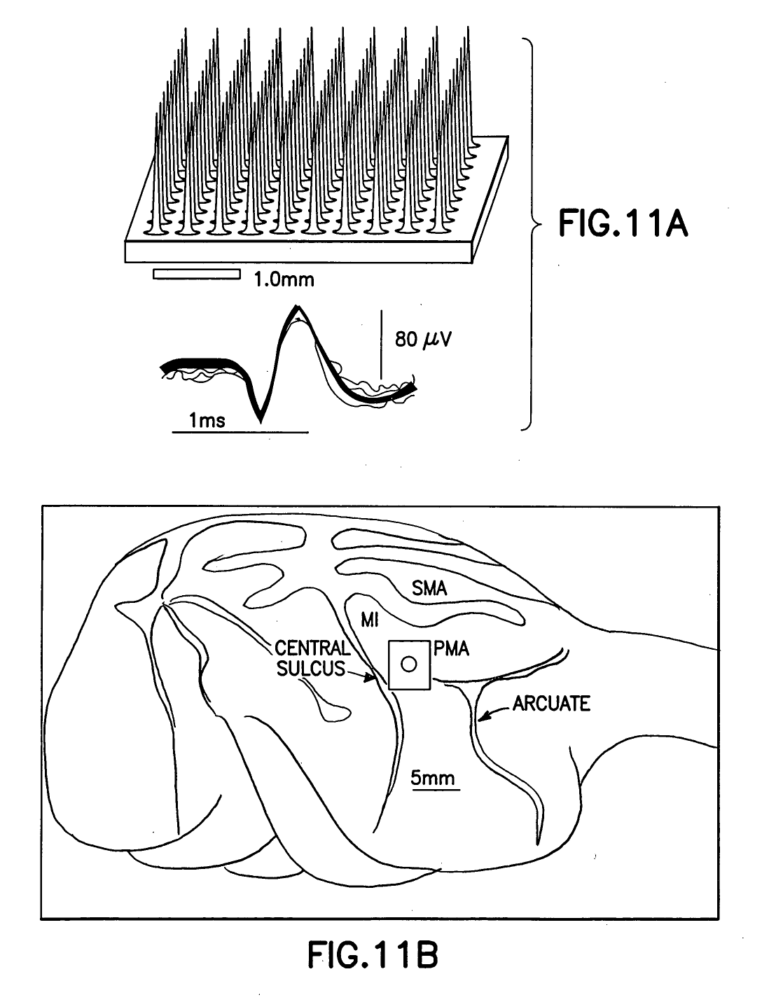

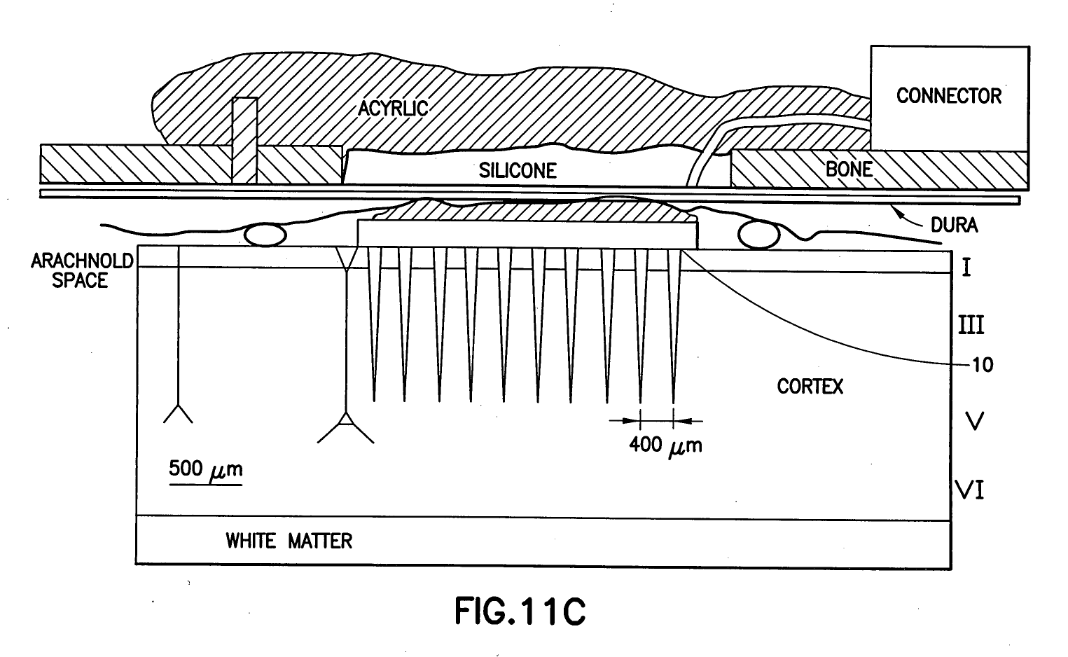

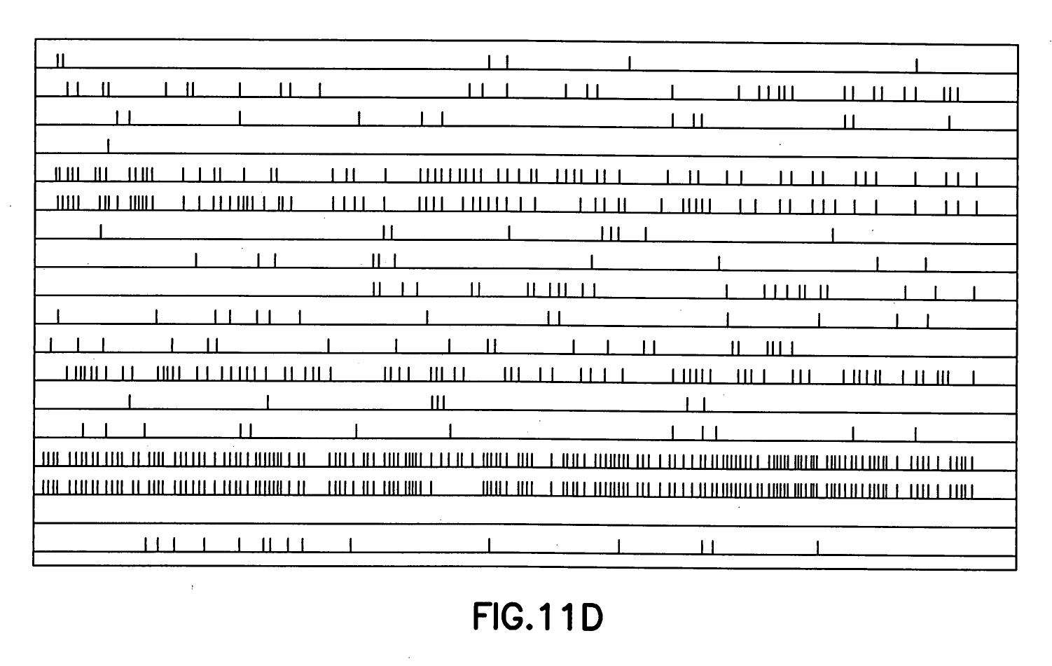

In an experiment simultaneous recordings were acquired from an array consisting of 100 microelectrodes implanted in the primary motor cortex (MI) of a Macaque monkey. Reference can be made to the multi-electrode array 10 shown in FIGS. 11A, 11B, 11C, and described in further detail below. Using the experimental paradigm of Paninski et al., “Temporal tuning properties for hand position and velocity in motor cortical neurons”, submitted, J. of Neurophysiology, 2001, the monkey viewed a computer monitor 16 and gripped a two-link, negligible-friction manipulandum 14 that was moved on a tablet 12 parallel to the floor (see FIG. 1A). In each trial, the monkey's task was to manually follow a target that moved smoothly and randomly on the screen with visual feedback of its hand position presented on the screen. For the data analyzed herein, there were 182 trials, each of which was approximately 8-10 seconds long. The hand position, velocity; and acceleration were recorded every 50 ms along with the firing rate for each of 25 neurons within the previous 50 ms. FIG. 11D shows an example of the spike patterns recorded from individual electrodes of the micro-electrode array 10.

A goal of this experiment was to reconstruct hand trajectory from the spiking activity (FIG. 1B) with the ultimate goal of providing control of prosthetic devices for the disabled. This may be viewed as a problem of inferring behavior from noisy measurements. The preferred approach of this first aspect or embodiment of the invention develops a Kalman filter framework (e.g., see Gelb, “Applied Optimal Estimation” MIT Press, 1974) for modeling the relationship between firing rates in the motor cortex and the position and velocity of the subject's hand. The method builds on previous work (see Brown at al., “A statistical paradigm for neural spike train decoding applied to position prediction from ensemble firing patterns of rat hippocampal place cells, J. of Neuroscience, 18(18):7411-7425, 1998) by applying these techniques to infer smooth hand motion from motor cortical activity. In the Kalman filter framework, the hand movement (position, velocity and acceleration) is modeled as the system state, and the firing rate is modeled as the observation (measurement). The approach specifies an explicit generative model that assumes the observation (firing rate in 50 ms) is a linear function of the state (hand kinematics) plus Gaussian noise. Similarly, the hand state at time t is assumed to be a linear function of the hand state at the previous time instant, plus Gaussian noise. The Kalman filter approach provides a recursive, and on-line, estimate of hand kinematics from the firing rate in non-overlapping 50 ms bins. The use of 50 ms bins is not limitation upon the practice of this invention, as other time periods, such as 70 ms, can be employed as well.

In contrast to prior art approaches, the presently preferred probabilistic approach provides a measure of confidence in the resulting estimates. This can be important when the output of the decoding method is to be used for later stages of analysis. The results of reconstructing hand trajectories from pre-recorded neural firing rates are compared with those obtained using more traditional linear filtering techniques (see Serruya et al., “Brain-machine interface: Instant neural control of a movement signal”, Nature, (416): 141-142, 2002; and Warland et al., “Decoding visual information from a population of retinal ganglion cells”, J. of Neurophysiology, 78(5): 2336-2350, 1997) using overlapping 550 ms windows. The results indicate that the presently preferred Kalman filter provides superior results when compared to the conventional linear filter.

In addition to providing a probabilistic inference framework that improves on the ad hoc linear filter, the Kalman filter also provides a tool for gaining insight into the neural coding. Training the Kalman filter involves recovering an observation matrix that linearly relates hand motions with neural firing. By analyzing this matrix one can observe that both the position and velocity of the hand are related to neural activity, while acceleration is much less important. Moreover, the framework provides a principled way of determining the optimal temporal “lag” between hand motion and the neural activity.

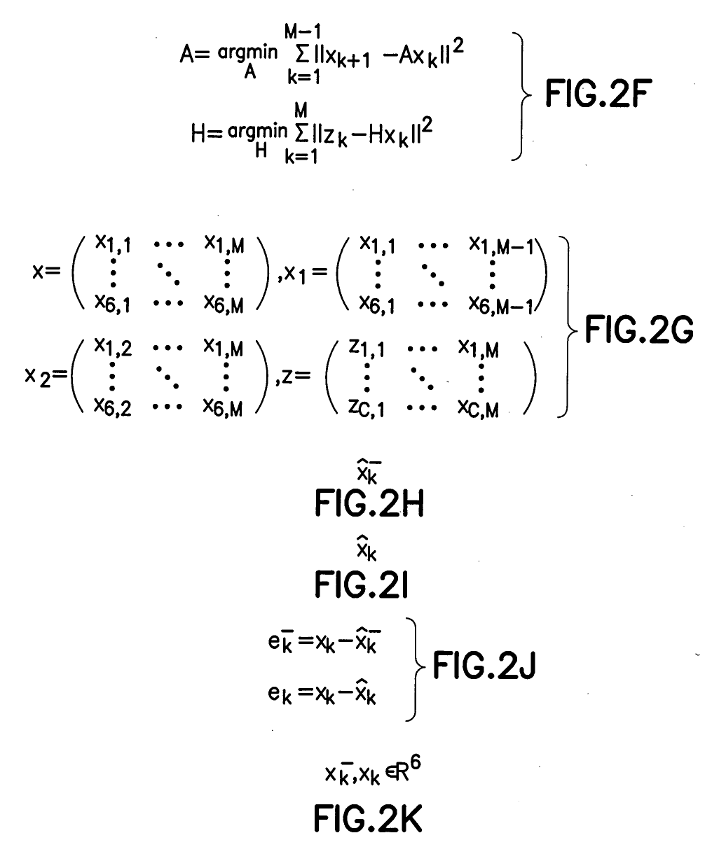

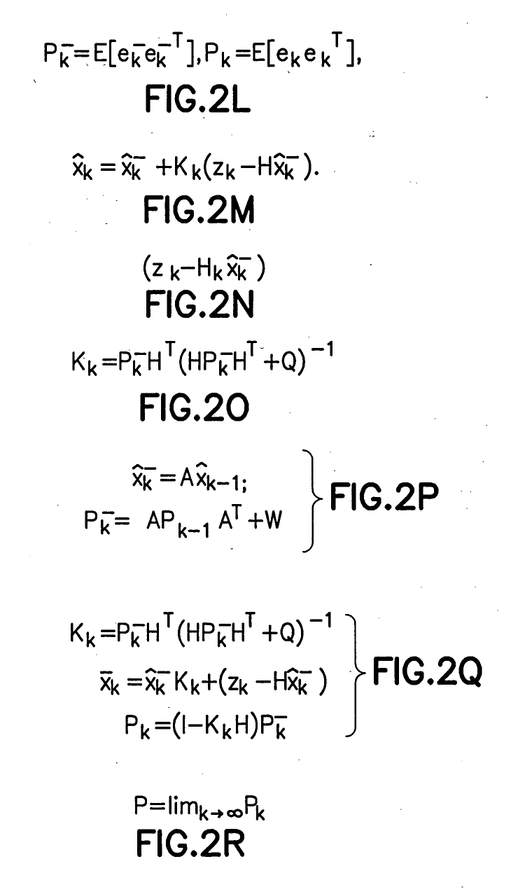

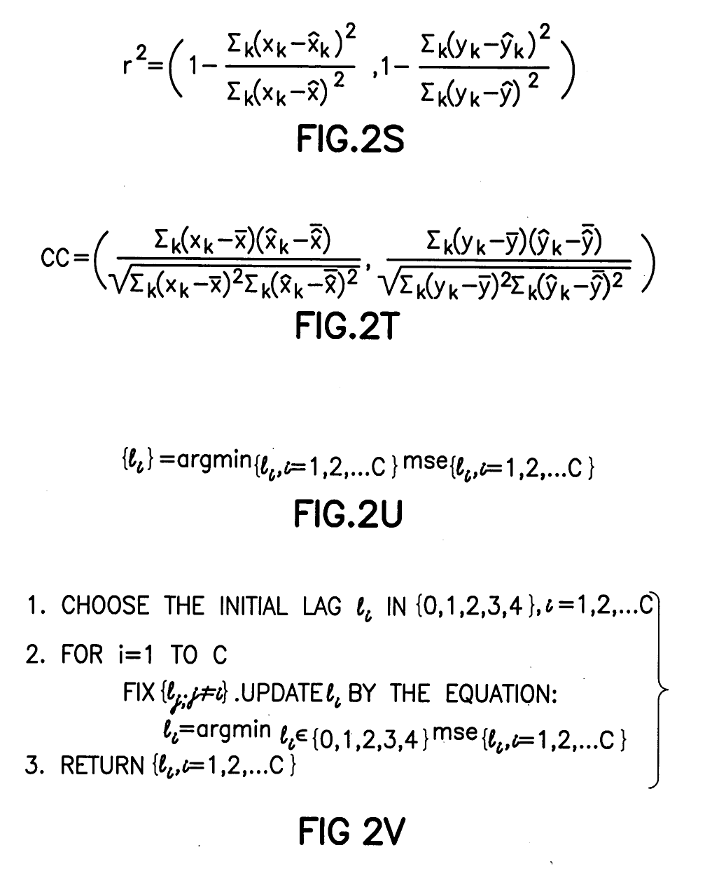

A goal is to estimate the state of the hand at the current instant in time, i.e. Xₖ=[x, y, yₓ, v_{y}, aₓ, a_{y}]_{K}^{T} representing x-position, y-position, x-velocity, y-velocity, xacceleration, and y-acceleration at time tₖ=kΔt, where Δt=50 ms. The Kalman filter model (see, for example, Gelb, “Applied Optimal Estimation” MIT Press, 1974, and Welch and Bishop, “An introduction to the Kalman filter”, Technical Report TR 95-041, University of North Carolina at Chapel Hill, Chapel Hill, N.C. 27599-3175,2001) assumes that the state is linearly related to the observations shown in FIG. 2A, which here represents a C×1 vector containing the firing rates at time tₖ for C observed neurons within 50 ms. In the experiments, C=25 cells, which is not a limitation upon the practice of this invention, as more or less than 25 cells may be sampled. This generative model of neural firing is formulated as:

zₖ=Hₖxₖ+qₖ, (1)

where k is an integer. FIG. 2B shows a matrix that linearly relates the hand state to the neural firing. It is assumed that the noise in the observations is zero mean and normally distributed, as shown in FIG. 2C. A discussion is made below of how to estimate Hₖ and the covariance matrix Qₖ from the training data.

The states are assumed to propagate in time according to the system model:

xₖ₊₁=Aₖxₖ+wₖ (2)

where Aₖ, shown in FIG. 2D, is the coefficient matrix and wₖ is the noise term, shown in FIG. 2E. This states that the hand kinematics (position, velocity, and acceleration) at time k+1 is linearly related to the state at time k. Once again it is assumed these estimates are normally distributed, and that Aₖ and Wₖ are learned from the training data.

In practice, Aₖ, Hₖ, Wₖ and Qₖ may change with time step k. However, it is preferred to make the common simplifying assumption that they are constant. Thus, one can estimate Aₖ, Hₖ, Wₖ and Qₖ from the training data using least squares estimation.

Learning (System Identification)

In this subsection, more details are provided as to how to learn the parameters in the model equations (1) and (2) shown above.

Assume that there are M time steps in the training data (containing states {xₖ} and the associated firing rates {zₖ}, k=1, . . . , M). Let x_{i,k} be ith element of xₖ at time tₖ (i.e. x-position, y-position, x-velocity, y-velocity, x-acceleration, or y-acceleration) and z_{j,k} be the neural firing rate in 50 ms of the jth cell at time tₖ, i=1, . . . 6, j=1, . . . , C, k=1, . . . , M.

If Aₖ, Hₖ, Wₖ and Qₖare independent of k, one can omit the subscript and denote them as A, H, W, Q. One can then estimate coefficient matrices A and H by least squares, as shown in FIG. 2F. The solutions of these equations are shown in FIG. 2G.

Furthermore, using the estimated A and H, one can estimate W and Q by:

W=(X₂−AX₁)(X₂−AX₁)^{T}/(M−1)

and

Q=(Z−HX)(Z−HX)^{T}/M.

With the estimated A, H, W, Q, the firing rate and the hand motion are encoded by Equations (1) and (2), respectively.

Estimation, (Kalman Filter Algorithm)

Given the generative encoding model defined above, a discussion is now made of the problem of decoding. That is, the problem of reconstructing hand motion from the firing rates of the cells.

For each xₖ, reconstruction using the Kalman filter algorithm has two steps:

i): (a priori step) predict xₖ from the state equation (2). This estimate is denoted by the term shown in FIG. 2H.

ii): (a posteriori step) update the estimate of FIG. 2H by using the information of the firing rate at time tₖ. The updated estimate is denoted by the expression shown in FIG. 21.

Hereafter the discussion follows the conventional notation (see, for example, Welch and Bishop, “An introduction to the Kalman filter”, Technical Report TR 95-041, 2001, for a review of the conventional notation).

To evaluate the performance of the estimation, define the a priori and a posteriori errors as is shown in Equation (3) of FIG. 2J, and assume that the terms shown in FIG. 2K are unbiased estimates. The error can be characterized by the covariance matrix (in the one dimensional case, the covariance matrix is just the square of Euclidean distance between the real and estimated values). Define the a priori and a posteriori estimate error covariance matrices as shown in Equation (4) of FIG. 2L, respectively.

The a posteriori estimator is the final estimation for the state. The accuracy of the final estimation can be evaluated under MSE (mean-square error), which is, here, the trace of matrix Pₖ for each k. To simplify the estimation process, one assumes the estimators to be linear. Thus, one can denote the a posteriori state estimate as a linear combination of an a priori estimate and a weighted difference between an actual measurement and a measurement prediction, as shown in Equation (5) of FIG. 2M (see (Gelb, 1974, for details).

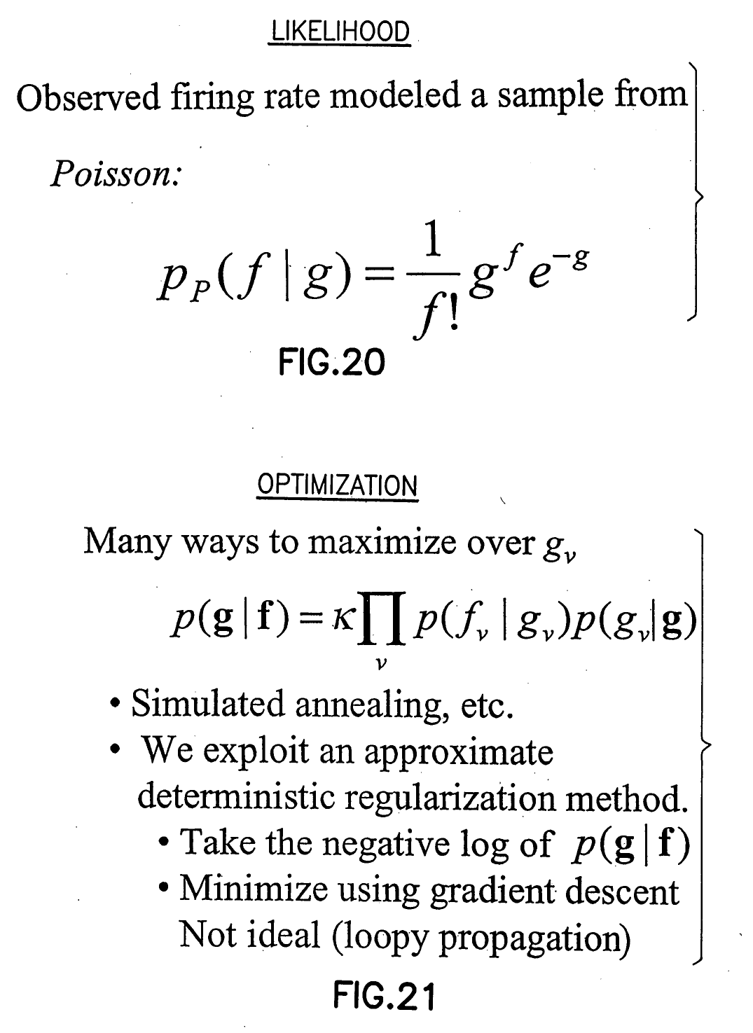

In Equation (5), the difference term shown in FIG. 2N is referred to as the measurement innovation, and the matrix Kₖ, is referred to as the gain matrix. The Kₖ which minimizes the MSE (i.e. tr(P_{k,})) has the form shown in Equation (6) of FIG. 20.

Note that Q is the measurement error matrix. If the error is significant, the gain Kₖ weighs lightly whereas if the error is not, the gain Kₖ weighs heavily. Thus the effect of new measurements on the state depends on the reliability of the data.

With all the above terms, one can describe the Kalman filter algorithm to reconstruct the state from the given firing rate.

Discrete Kalman filter time update equations:

At each time tₖ, obtain the a priori estimate from the previous time tₖ₋₁ and then compute its error covariance matrix as shown in Equations (7) and (8) of FIG. 2P.

Measurement Update Equations:

Using the estimate term shown in FIG. 2H and the firing rate zₖ, update the estimate using Equation (5) in FIG. 2M, and compute its error covariance matrix. The process is described by Equations (9), (10) and (11) shown in FIG. 2Q.

At each time instant, the Kalman filter iterates between the above two steps and provides an “on-line” estimate of hand kinematics every, by-example, 50 ms. Note that Equations (8), (9) and (1) are independent of the test data. Thus, one can compute them “off-line” before the “online” estimation. In practice, this is an attractive property of the Kalman filter that enables one to a priori estimate the performance of the reconstruction. Assuming the term shown in FIG. 2R, then tr(P) estimates the mean-squared error of the reconstruction.

Experimental Results

The experiments described below used 182 pre-recorded trials (Paninski at al., “Temporal tuning properties for hand position and velocity in motor cortical neurons”, submitted, J. of Neurophysiology, 2001,). Cross-validation was used in testing both the encoding and decoding. The 182 trials are divided into seven sets of 26 trials. For each of the seven sets, the model (A, H, W, Q) was trained with the remaining six data sets and the reconstruction performance for the 26 trials was tested in the excluded set. In this way it is possible to test the model on all 182 trials such that the test data is always excluded from the training data.

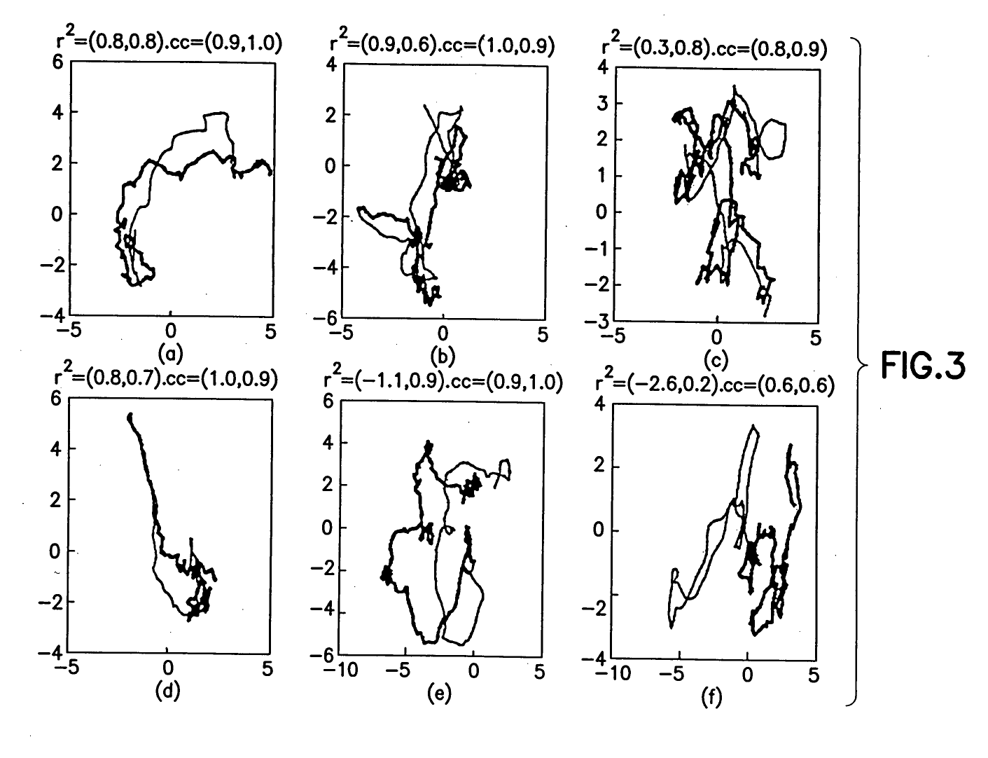

In each testing trial, let the predicted initial condition equal the real initial condition and P⁻ₒ=0. Then the update equations described above are applied. Some exemplary reconstructed trajectories are shown in FIG. 3. By inspection, the reconstructions suggest that the mean firing rates do encode information about the arm movement, and that the Kalman filter algorithm is a reliable technique to decode the movement.

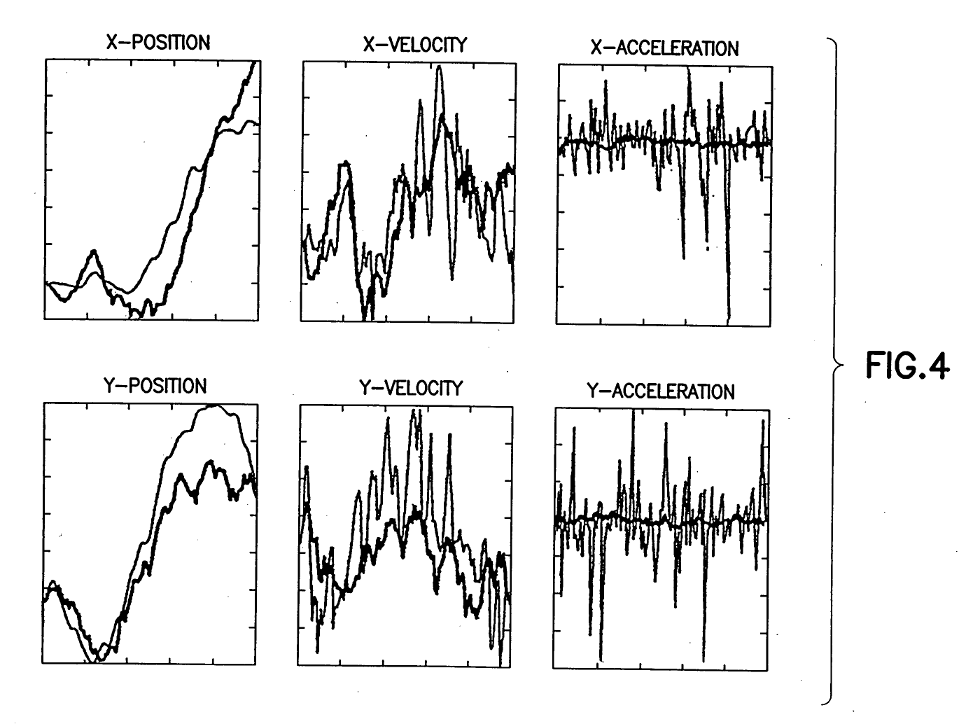

FIG. 4 shows the reconstruction of each component of the state variable for one example trial. Notice that the reconstruction of position and velocity is fairly successful, but the method fails to recover acceleration. This is discussed below.

Conventional r² squared error is used in the expression shown in FIG. 2S to illustrate the accuracy of the reconstruction in both x- and p-position, where xₖ and yₖ are the true values and x⁻ and y⁻ are the mean of these x and y values, respectively.

In FIGS. 3(e) and (f) the shapes of the reconstructed trajectories are similar to the true trajectories but they are spatially shifted resulting in a large r² error. The correlation coefficient (cc) provides a more appropriate measure of trajectory shape reconstruction, where cc is equal to the expression shown in FIG. 2T Stability

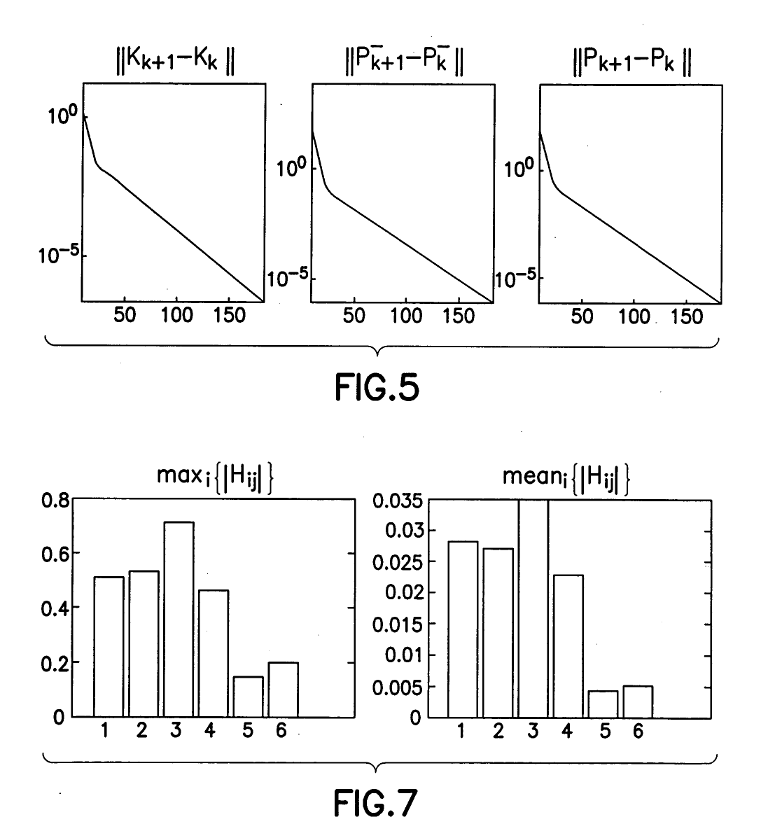

Equations (8), (9) and (11) define the evolution of the gain matrix Kₖ, and error matrices Pₖ, P′ₖ. For reliable estimates these matrices should be stable. FIG. 5 illustrates that they stabilize (converge) very quickly and then remain constant.

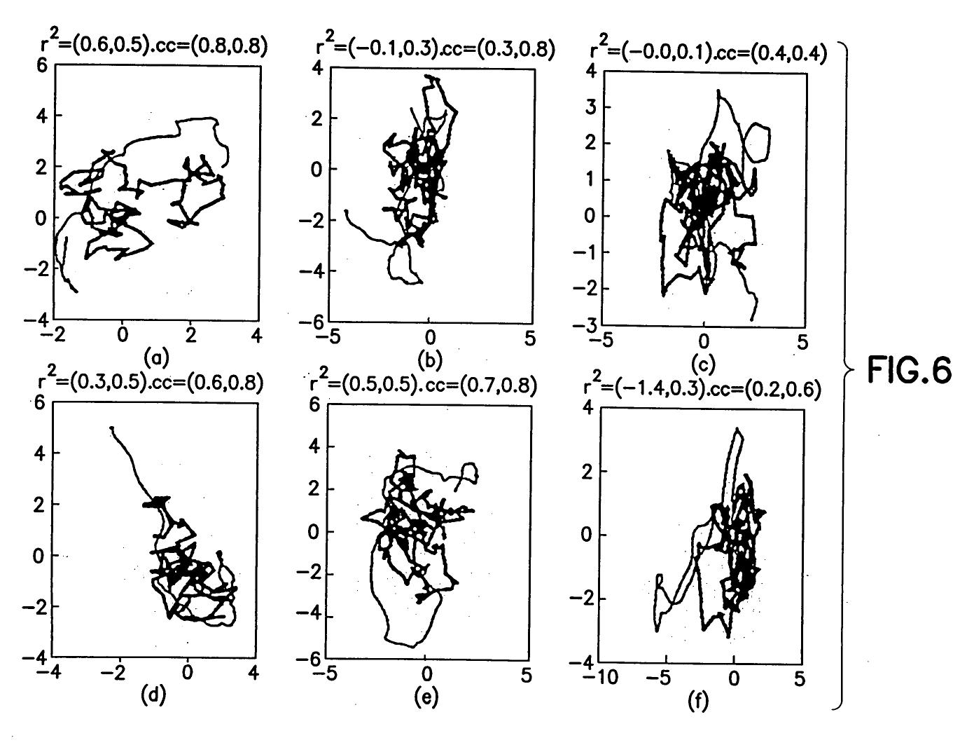

A linear filter reconstruction is shown in FIG. 6. Compared with FIG. 3, one can see that the Kalman filter reconstruction is smoother and more similar to the actual trajectory, while that of the linear filter appears chaotic. In FIG. 4 one can see that the Kalman filter roughly reconstructs velocity in addition to position. This suggests that velocity is correlated with firing, and that the comparison with linear filtering on position alone may be unfair (though the linear filter uses more data at a given time instant).

Note that the linear filter can implicitly capture information about the relationship between position and velocity because it exploits data over multiple time instants. In the experimental data presented here, however, position and velocity are nearly conditionally independent by design. This gives an advantage to the Kalman filter, which explicitly models velocity as part of the system state.

In cross-validation, each trial is chosen as test data once and only once, and the r² error and the correlation coefficient of the reconstruction (by both the linear and Kalman filters) are calculated. While the r² error of the Kalman reconstruction was found to be better than the linear filter reconstruction in about half of the tested cases, the correlation coefficient was better 91% of the time for the x-position and 80% of the time for y-position.

While linear filtering is extremely simple, it lacks many of the desirable properties of the Kalman filter. The linear filtering method requires long windows in which to collect data. For rapid motions, this long time window is generally inappropriate, yet smaller time windows lead to very inaccurate results. Additionally, the linear filter does not make the system dynamics and noise models explicit. In contrast, the Kalman filter provides an explicit generative model, a clear probabilistic interpretation, an incremental estimate of the state that improves over time, and an estimate of the uncertainty in the state. Computationally, the Kalman filter is simple to train, and the real-time implementation of tracking is not complex.

Analysis

The firing rate was described above as a linear stochastic function of position, velocity and acceleration. Consider now a posteriori the redundancy of the model. In FIG. 4 the reconstruction of position and velocity are reasonable, while acceleration is not well recovered. Heuristically, it appears that acceleration is redundant. There are two reasons to support this observation. First, acceleration is a second order difference of position, thus measurements of acceleration tend to be very noisy in real data.

Second, by examining the linear coefficient matrix H one can evaluate the significance of acceleration in the estimation. Recall that H encodes the relationship between the kinematics and the firing rate. Each column of H contains the C coefficients for a particular system variable. The normalized magnitude of these coefficients is related to how much each state variable contributes to the model. Each column is normalized by the effective range of the state variable to create a new matrix H^{˜} in which the absolute value of the coefficients are all approximately scaled to the same range. The maximum and mean of each column of H^{˜} provide ad hoc measures of the coefficient significance and are plotted in FIG. 7. By inspection of H^{˜} it appears that the acceleration has a weak effect on the model relative to position and velocity.

By using only position and velocity to model the firing rate, and repeating the cross-validation experiments above, with the reduced state space, the system state becomes xₖ=[x, y, vₓ, v_{y}]^{K}^{T}, and A, H, W and Q are updated accordingly.

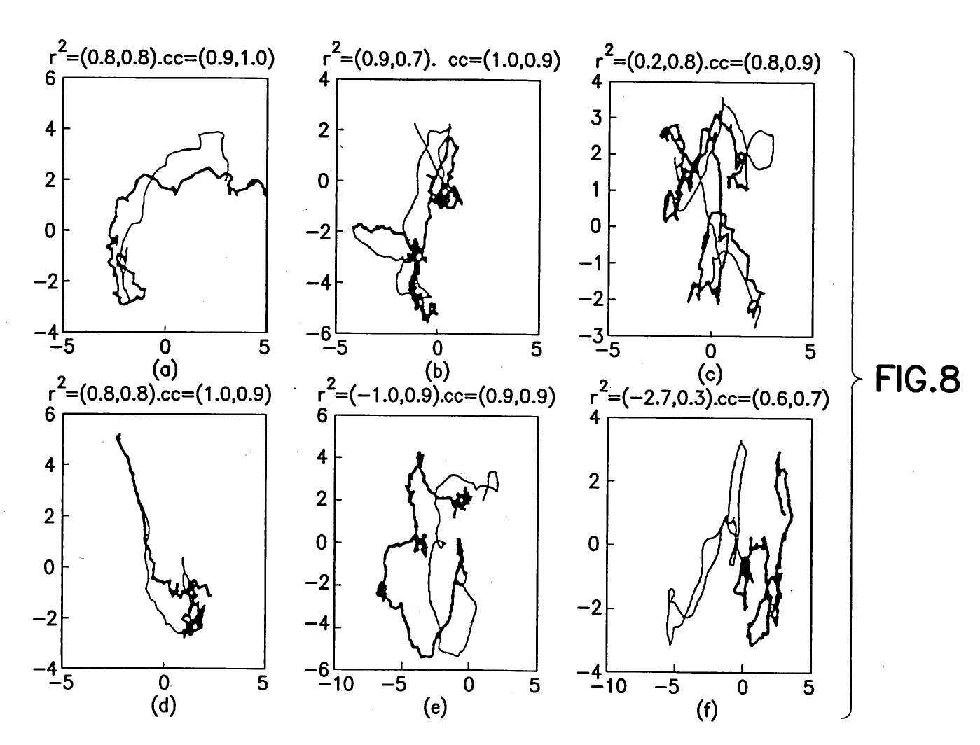

FIG. 8 shows the Kalman filter reconstruction on a few test trials. Comparing FIG. 8 with FIG. 3, one can see that the simplified model and the original model give a visually similar reconstruction. This further supports the conjecture that the acceleration is redundant.

Optimal Lags

The physical relationship between neural firing and arm movement means that there exists a positive time lag between them. If an “optimal lag” can be determined, it should improve the model encoding and should improve the accuracy of the decoding.

Thus far, zₖ has represented the vector of C cells' firing rates at time tₖ, but positive and negative time lags may be considered instead. A discussion is now made of an optimal time lag both uniformly (i.e., the same for all cells) and non-uniformly. Different lags produce different data for the zₖ. {Pₖ} s are the a posteriori estimate error co-variances defined in Equation (4) of FIG. 2L. This Kalman framework is exploited to find the optimal lag; that is, the time lag that results in the lowest estimate error. Since {Pₖ} converges rapidly, the optimal lag is obtained when the trace of matrix Pₖ (for k large enough) is smallest over all possible lags.

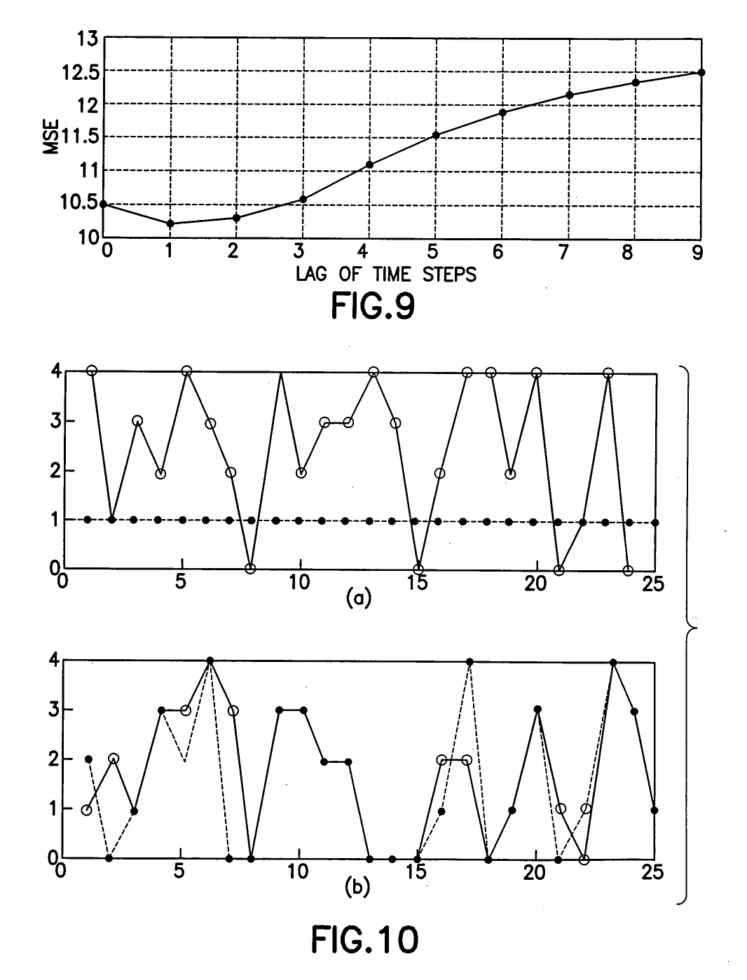

Uniform time lag: For each j ε{0, 1, 2, . . . , 9}. define zₖ as the vector of C cells' firing rates at time tₖⱼ, then fit the model with training data. {Pₖ} are computed “off-line”. The mean-square error tr(Pₖ) is plotted in FIG. 9 for a large enough k, where j=0, 1, . . . , 9.

FIG. 9 shows that the smallest estimation error is achieved when the neural cells have lag for one or two time steps (50-100 ms). For longer lags, the error increases monotonically with the lag time.

Non-uniform time lag: More practically the neural cells may not exhibit uniform spiking activity. Some of them may act very fast, whereas others may act more slowly. From the analysis of the uniform lag, it appears that the optimal time lag of the cells should not be too long. To simplify the data analysis, assume that the optimal lag for all cells is less than, for example, four time steps (200 ms).

Due to this more subtle situation, it is desirable to reorganize the notation: let lᵢε{0,1,2,3,4}be the lag steps of ith cell i=1,2, . . . , C. The kth firing rate vector is zₖ=(z_{1,k}, z_{2,k,} . . . ,z_{C,k}) in which each z_{i,k} is the firing rate of cell i at time step k−lᵢ. For each different choice of {lᵢ}in {0,1,2,3,4}, train the Kalman filter. The Kalman filtering algorithm generates the error covariance matrix Pₖ (for k large enough). Letting mse_{{li, i=1,2, . . . C}}=tr(Pₖ), the goal is to find the optimal {lᵢ}, as shown in FIG. 2U.

A brute force search of all possibilities would require computing the Kalman filter result for 5²⁵ possibilities for the exemplary data set. This is impractical so, instead, one may assume that the correlation of the firing rate among the cells is weak, and then obtain a sub-optimal time lag from the greedy algorithm shown in FIG. 2V.

The algorithm shown in FIG. 2V expects that the Kalman filtering algorithm be applied to the training data only 3×25=125 times. With two initial conditions: one with a uniform lag of 50 ms (1 time step), and the other with a random lag, the result of the operation of the greedy algorithm of FIG. 2V is shown in FIG. 10. The different initial conditions result in similar lags, which confirms the assumption that the firing of all cells has weak correlation. Moreover, these two sub-optimal time lag solutions have the mean-square error 9.88 and 9.88, which is much less than that of the uniform time lag in FIG. 9 (where the minimum is 10.28 at a lag of 50 ms). This suggests that a non-uniform time lag is superior to a uniform time lag.

In summary, described above with respect to the first aspect of this invention has been a procedure to apply the discrete linear Kalman filter to model hand movement and neural spiking activity. It is a rigorous probabilistic approach with a well-understood theory. Experimental results show the superiority of the Kalman filter to linear filtering. Moreover, the recursive estimation in 50 ms non-overlapping time bins provides a computationally efficient filtering algorithm. In addition to decoding, the approach is useful for analysis. For example, examination of the measurement matrix gives heuristic insight into the coding problem (acceleration appears to not be encoded). Additionally, the framework allows the analysis of optimal lag times that result in improved state estimates. By making its assumptions explicit, and by providing an estimate of uncertainty, the Kalman filter offers significant advantages over previous methods.

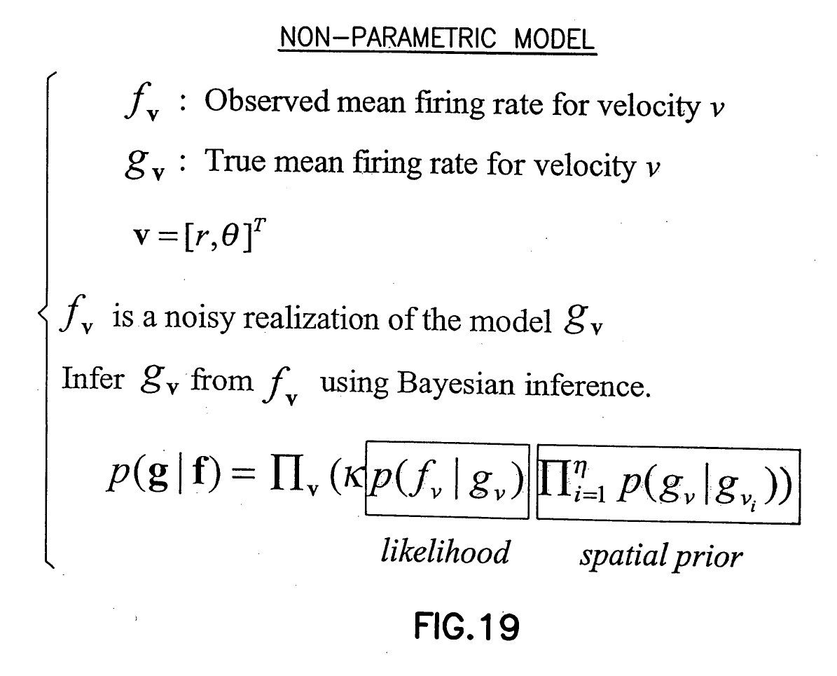

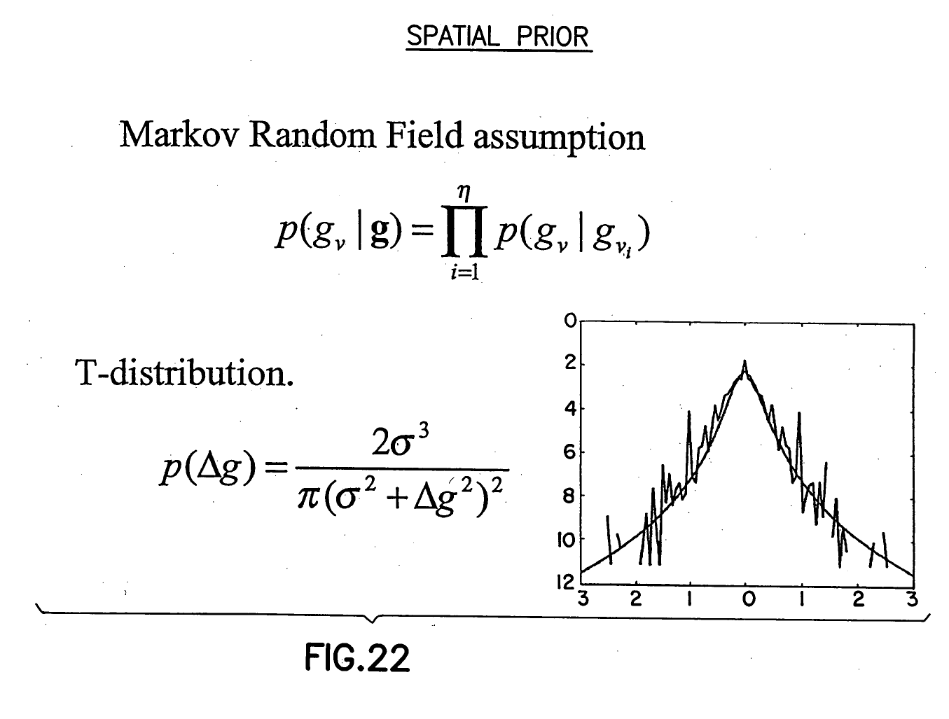

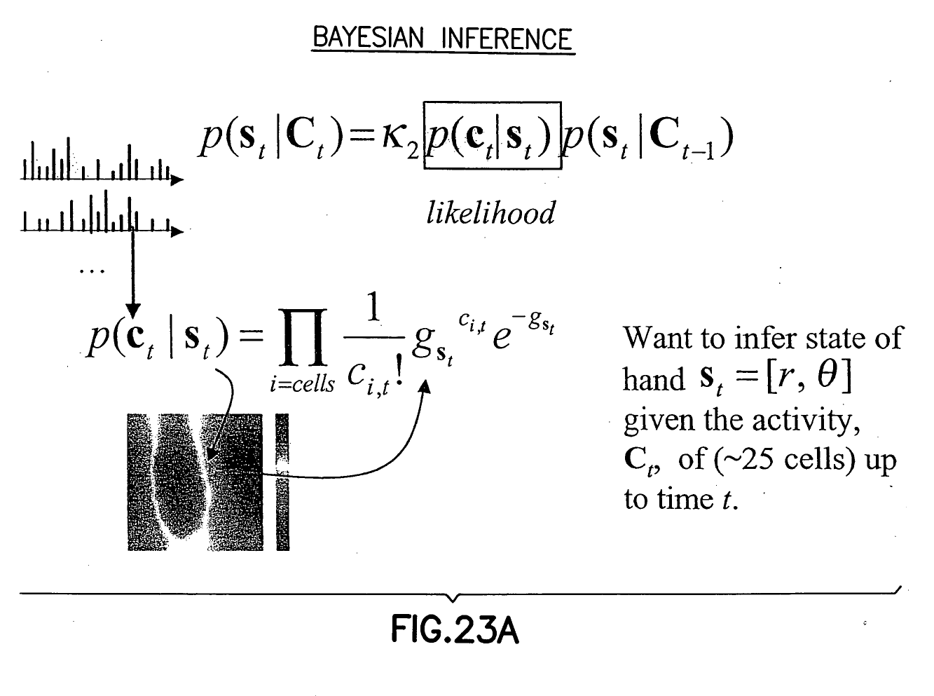

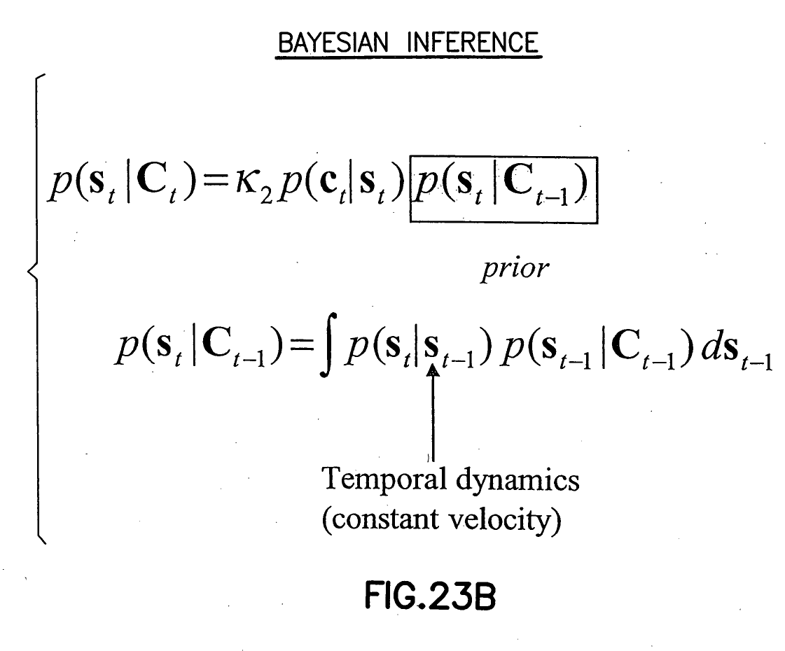

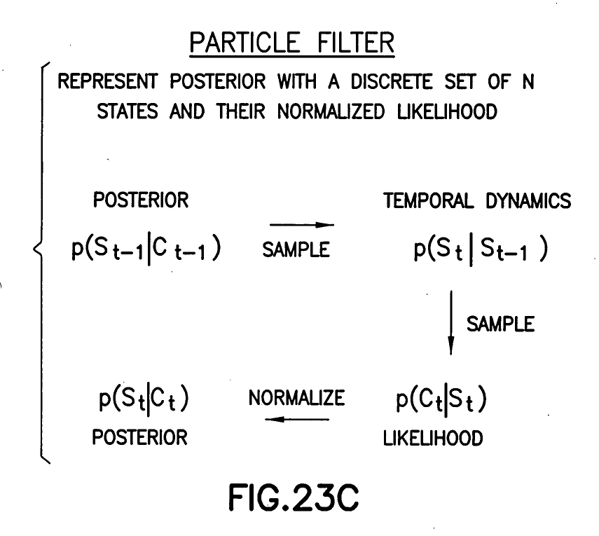

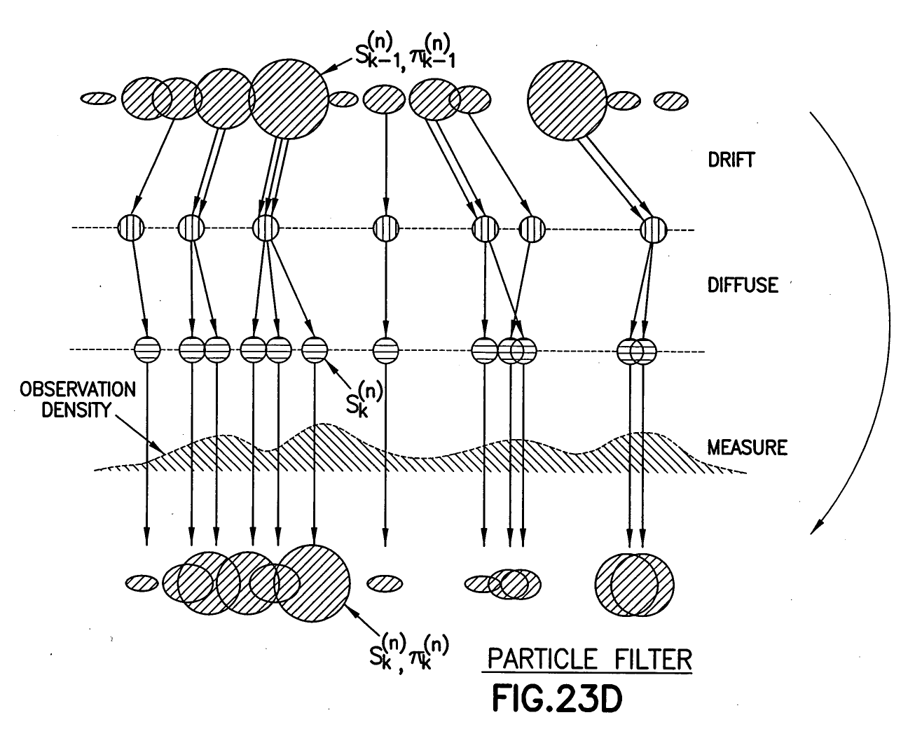

What follows now is a discussion of the second aspect of this invention, that is, the use of a non-parametric representation of neuron firing activity that is learned using a Bayesian model, and the inference of an a posterior probability distribution over hand motion, conditioned on the sequence of neural test data using Bayesian inference. The learned firing models of multiple cells are used to define a non-Gaussian likelihood term that is combined with a prior probability for the kinematics. Also described is a particle filtering method to represent, update, and propagate the posterior distribution over time. General reference with regard to this embodiment of the invention can be made to FIGS. 19, 20, 21, 22, 23A, 23B, 23C and 23D for illustrating aspects the non-parametric model, likelihood, optimization, a spatial prior, Bayesian inference and the particle filter model.

The goals are threefold: (i) to investigate the nature of encoding in motor cortex, (ii) to characterize the probabilistic relationship between arm kinematics (hand position or velocity) and activity of a simultaneously recorded neural population, and (iii) to optimally reconstruct (decode) hand trajectory from population activity to smoothly control a prosthetic robot arm.

The above-mentioned multi-electrode array 10 (FIGS. 11A, 11B, 11C) is used to simultaneously record the activity of, in this case, 24 neurons in the arm area of primary motor cortex (MI) in awake, behaving, Macaque monkeys. This activity is recorded while the monkeys manually track a smoothly and randomly moving visual target on a computer monitor. Statistical learning methods are used to derive Bayesian estimates of the conditional probability of firing for each cell given the kinematic variables (considering here only hand velocity). Specifically, non-parametric models of the conditional firing are used, that are learned using regularization (smoothing) techniques with cross-validation. The results suggest that the cells encode information about the position and velocity of the hand in space. Moreover, the non-parametric models provide a better explanation of the data than previous parametric models and provide new insight into neural coding in MI.

Decoding involves the inference of the hand motion from the firing rate of the cells. In particular, it is desirable to represent the posterior probability of the entire hand trajectory conditioned on the observed sequence of neural activity (spike trains). The nature of this activity results in ambiguities and a non-Gaussian posterior probability distribution. Consequently, it is preferred to represent the posterior non-parametrically using a discrete set of samples. This distribution is predicted and updated in non-overlapping 50 ms time intervals using a Bayesian estimation method referred to as particle filtering (see M. Isard et al., “Condensation-conditional density propagation for visual tracking”, IJCV, 29(1):5-28, 1998). Experiments with real and synthetic data suggest that this approach provides probabilistically sound estimates of kinematics, and allows the probabilistic combination of information from multiple neurons, the use of priors, and the rigorous evaluation of models and results.

Neural Recording

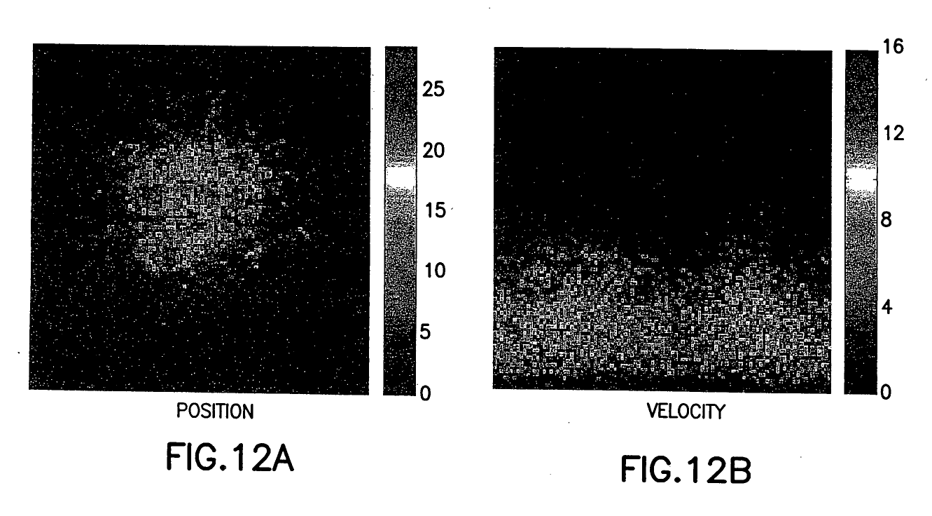

The design of the experiment and data collection is described in detail in Paninski et al., “Temporal tuning properties for hand position and velocity in motor cortical neurons”, submitted, J. of Neurophysiology, 2001. Summarizing, the ten-by-ten array 10 of electrodes is implanted in the primary motor cortex (MI) of a Macaque monkey. Neural activity in motor cortex has been shown to be related to the movement kinematics of the animal's arm and, in particular, to the direction of hand motion. Previous behavioral tasks have involved reaching in one of a fixed number of directions. To model the relationship between continuous, smooth, hand motion and neural activity, it is preferred to use a more complex scenario where the monkey performs a continuous tracking task in which the hand is moved on the 2D tablet 12 while holding the low-friction manipulandum 14 that controls the motion of a feedback dot viewed on the computer monitor 16, as shown in FIG. 1A. The monkey receives a reward upon completion of a successful trial in which the manipulandum 14 is moved to keep the feedback dot within a pre-specified distance of the target. The path of the target is chosen to be a smooth random walk that effectively samples the space of hand positions and velocities: measured hand positions and velocities have a roughly Gaussian distribution (FIGS. 12A and 12B). Neural activity is amplified, waveforms are thresholded, and spike sorting is performed off-line to isolate the activity of individual cells. Recordings from 24 motor cortical cells are measured simultaneously with hand kinematics.

Modeling Neural Activity

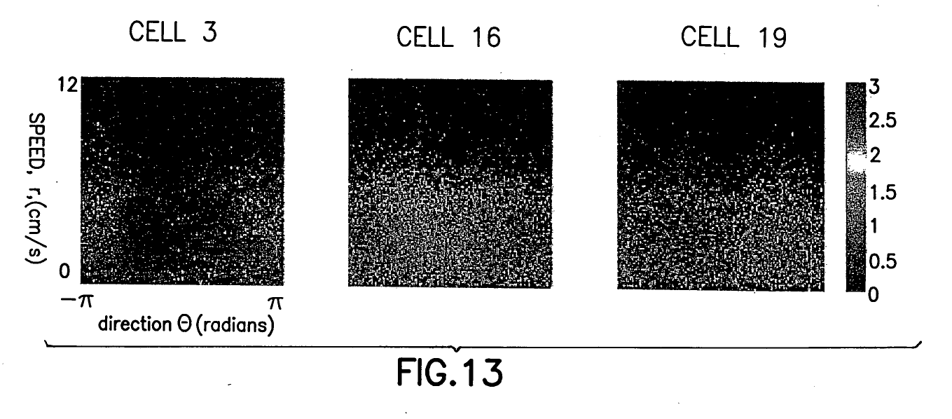

FIG. 13 shows the measured mean firing rate within 50 ms time intervals for three cells conditioned on the subject's hand velocity. The neural firing activity in FIG. 13 can be viewed as a stochastic and sparse realization of some underlying model that relates neural firing to hand motion. Similar plots are obtained as a function of hand position. Each plot can be thought of as a type of “tuning function” (see Paninski et al.) that characterizes the response of the cell conditioned on hand velocity. A non-parametric model of the underling activity is herein explored and, adopting a Bayesian formulation, a maximum a posterior (MAP) estimate is sought of a cell's conditional firing.

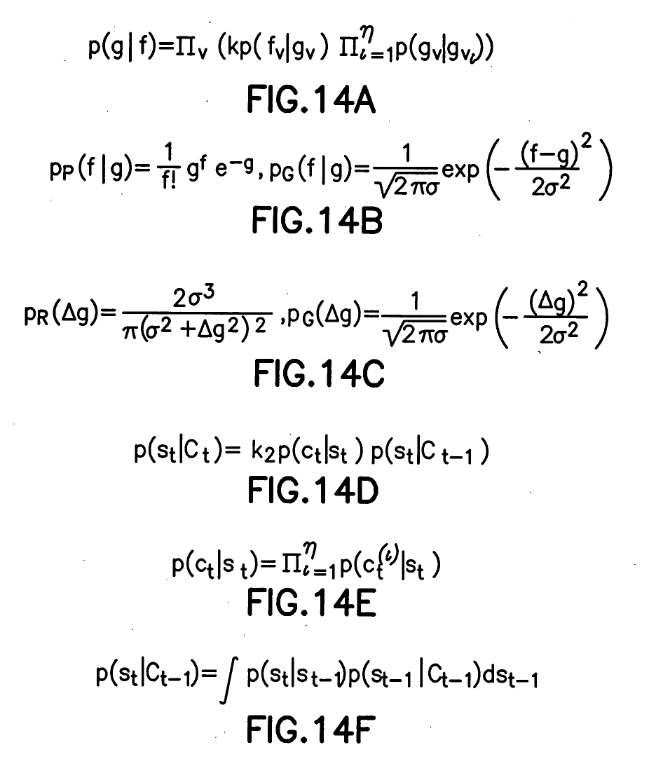

Adopting a Markov Random Field (MRF) assumption (see, for example, S. Geman et al., “Stochastic relaxation, Gibbs distributions and Bayesian restoration of images”, PAMI, 6(6):721-741, November 1984), let the velocity space, v=[r,θ]^{T} be discretized on a 100×100 grid. Let g be the array of true (unobserved) conditional neural firing and f be the corresponding observed mean firing. The desired posterior probability is shown in Equation (1) of FIG. 14A, where K is a normalizing constant independent of g, fᵥ and gᵥ are the observed and true mean firing at velocity v respectively, gᵥᵢ represents the firing rate for the ith neighboring velocity of v, and the neighbors are taken to be the four nearest velocities (\acute{η}=4).

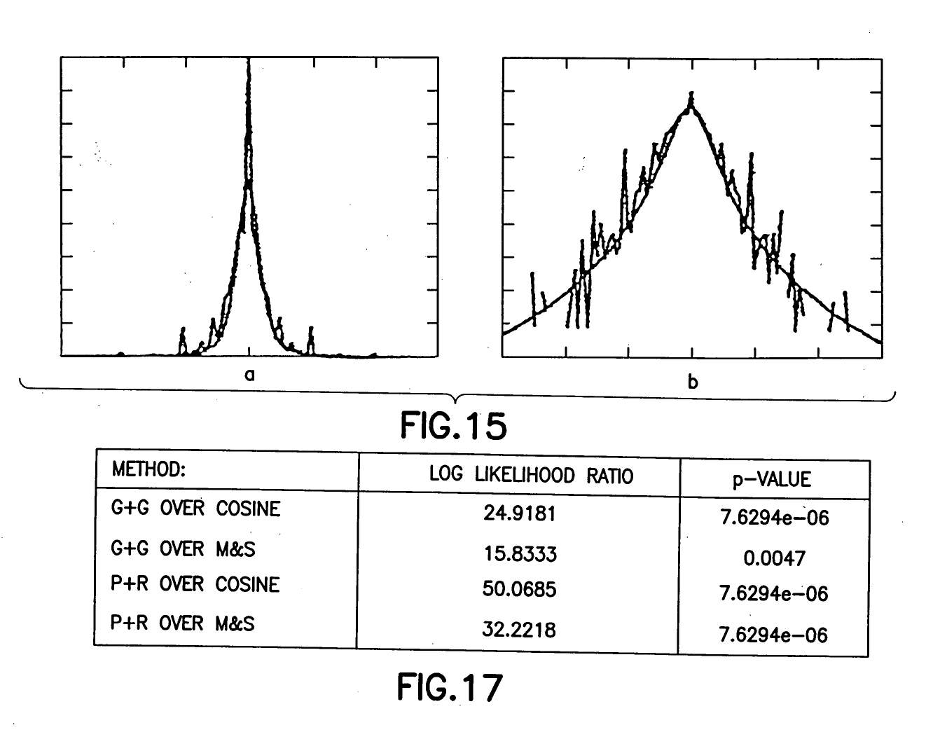

The first term on the right hand side represents the likelihood of observing a particular firing rate fᵥ given that the true rate is gᵥ. Here, one can compare two generative models of the neural spiking process within 50 ms; a Poisson model, pₚ, and a Gaussian model, p_{G}, as shown in FIG. 14B. The second term is a spatial prior probability that encodes expectations about Δg, the variation of neural activity in velocity space. The MRF prior states that the firing, gᵥ, at velocity v depends only on the firing at neighboring velocities. We consider two possible prior models for the distribution of Δg: Gaussian and “robust”. A Gaussian prior corresponds to an assumption that the firing rate varies smoothly. A robust prior assumes a heavy-tailed distribution of the spatial variation (see FIG. 15), Δg, (derivatives of the firing rate in the r and 0 directions) and implies piecewise smooth data. The two spatial priors are shown in FIG. 14C.

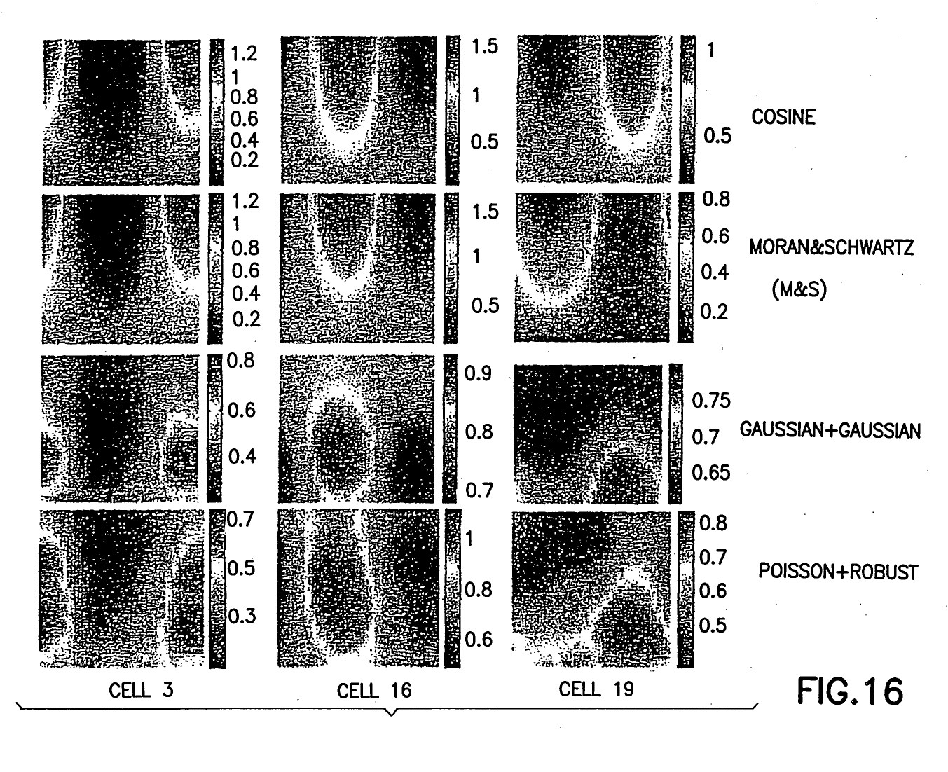

The various models (cosine, a modified cosine), Gaussian+Gaussian, and Poisson+Robust) are fit to the training data as shown in FIG. 16. In the case of the Gaussian+Gaussian and Poisson+Robust models, the optimal value of the σ parameter is computed for each cell using cross-validation. During cross-validation, each time 10 trials out of 180 are left out for testing and the models are fit with the remaining training data. The log likelihood of the test data is then computed, given the model. This provides a measure of how well the model captures the statistical variation in the training set and is used for quantitative comparison. In this example the entire procedure is repeated 18 times for different test data sets.

The solution to the Gaussian+Gaussian model can be computed in closed form, but for the Poisson+Robust model no closed form solution for g exists, and an optimal Bayesian estimate could be achieved with simulated annealing (see S. Geman et al.). Instead, it is preferred to derive an approximate solution for g by minimizing the negative logarithm of the distribution using standard regularization techniques (see, for example, M. Black et al., “On the unification of line processes, outlier rejection, and robust statistics with applications in early vision”, IJCV, 19(1):57-92, 1996, and D. Terzopoulos, “Regularization of inverse visual problems involving discontinuities”, PAMI, 8(4):413-424, 1986) with missing data, the learned prior model, and a Poisson likelihood term. Simple gradient descent, such as is described by M. Black et al., with deterministic annealing provides a reasonable solution. Note that the negative logarithm of the prior term can be approximated by the robust statistical error function ρ(Δg)=Δg/((σ²+(Δg)²), which has been used in machine vision and image processing for smoothing data with discontinuities.

FIG. 16 shows the various estimates of the receptive fields for the different models. Observe that the pattern of firing is not Gaussian. Moreover, some cells appear to be tuned to motion direction, θ, and not to speed, r, resulting in vertically elongated patterns of firing. Other cells (e.g. cell 19) appear to be tuned to particular directions and speeds; this type of activity is not well fit by the parametric models. Table 1 in FIG. 17 shows a quantitative comparison using cross-validation. The log likelihood ratio (LLR) is used to compare each pair of models: LLR (model 1, model 2) log(Pr(observed firing|model 1)/Pr(observed firing|model 2)). The positive values in Table I indicate that the non-parametric models perform better in explaining new data than the parametric models, with the Poisson+Robust fit providing the best description of the data. This Poisson+Robust model implies that the conditional firing rate is well described by regions of smooth activity with relatively sharp discontinuities between them. The non-parametric models reduce the strong bias of the parametric models with a slight increase in variance and hence achieve a lower total error.

Temporal Inference

Given a set of neural measurements the goal is to infer the motion of the hand over time. Related approaches have exploited simple linear filtering methods which do not provide a probabilistic interpretation of the data that can facilitate analysis and support the principled combination of multiple sources of information. Related probabilistic approaches have exploited Kalman filtering (see, again, Brown et al., “A statistical paradigm for neural spike train decoding applied to position prediction from ensemble firing patterns of rat hippocampal place cells, J. of Neuroscience, 18(18):7411-7425, 1998). It is noted, however, that the learned models of neural activity are not Gaussian, and the dynamics of the hand motion may be non-linear. Furthermore, with a small number of cells, the interpretation of the neural data may be ambiguous and the posterior probability of the kinematic variables, given the neural activity, may be best modeled by a non-Gaussian, multi-modal, distribution. To cope with these issues in a sound probabilistic framework this aspect of the invention exploits a non-parametric approach that uses factored sampling to discretely approximate the posterior distribution, and particle filtering to propagate and update this distribution over time (see, again, M. Isard et al., “Condensation-conditional density propagation for visual tracking”, IJCV, 29(1):528, 1998).

Let the state of the system be sₜ=[r,θ] at time t. Let c₁⁽ⁱ⁾ be the mean firing rate of cell i at time t where the mean firing rate is estimated within non-overlapping 50 ms temporal windows. Also,

$$let {c}_{t} = [ {c}_{t}^{( 1 )} … {c}_{t}^{( n )} ]$$

represent the firing rate of all n cells at time t. Similarly let

$${C}_{t}^{( i )}$$

represent the sequence of these firing rates for cell i up to time t and let

$${C}_{t} = [ {C}_{t}^{( 1 )} … {C}_{t}^{( n )} ]$$

represent the firing of all n cells up to time t.

Assume as well that the temporal dynamics of the states, St, form a Markov chain for which the state at time t depends only on the state at the previous time instant:

p(Sₜ₋₁)=p(Sₜ₋Sₜ₋₁),

where Sₜ=[sₜ, . . . , sₒ] denotes the state history. Also assume that given St, the current observation cₜ and the previous observations Cₜ₋₁ are independent.

Using Bayes rule and the above assumptions, the probability of observing the state at time t given the history of firing can be written as shown in Equation (2) of FIG. 14D, where κ₂ is a normalizing term that insures that the distribution integrates to one. The likelihood term shown in FIG. 14E assumes conditional independence of the individual cells, where the likelihood for the firing rate of an individual cell is taken to be a Poisson distribution with the mean firing rate for the speed and velocity given by sₜ determined by the conditional firing models. Plotting this likelihood term for a range of states reveals that its structure is highly non-Gaussian with multiple peaks.

The temporal prior term, p(sₜ|C₋₁) can be written as shown in Equation (3) of FIG. 14F, where p(sₜ|sₜ₋₁) embodies the temporal dynamics of the hand velocity which are assumed to be constant with Gaussian noise; that is, a diffusion process. It is instructive to note that p(sₜ₋₁|Cₜ₋₁) is the posterior distribution over the state space at time t−1.

The posterior, p(sₜ|Cₜ), is represented with a discrete, weighted set of, by example, 3000 random samples that are propagated in time using a standard particle filter (see again M. Isard et al. for details). Unlike previous applications of particle filtering, the likelihood of firing for an individual cell in 50 ms provides little information. For the posterior to be meaningful one should combine evidence from multiple cells. Experiments indicate that the responses from only 24 cells are insufficient for this task. To demonstrate the feasibility of the particle filtering method, the inventors have synthesized approximately 1000 cells by taking the learned models of the 24 cells and translating them along the 0 axis to generate a more complete covering of the velocity space. Note that the assumption of such a set of cells in MI is quite reasonable, given the sampling of cells observed in multiple monkeys.

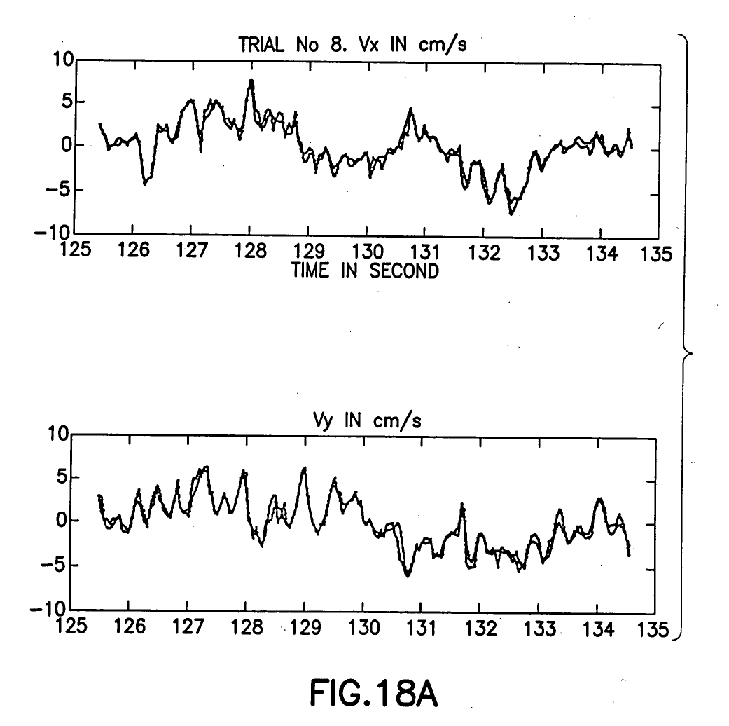

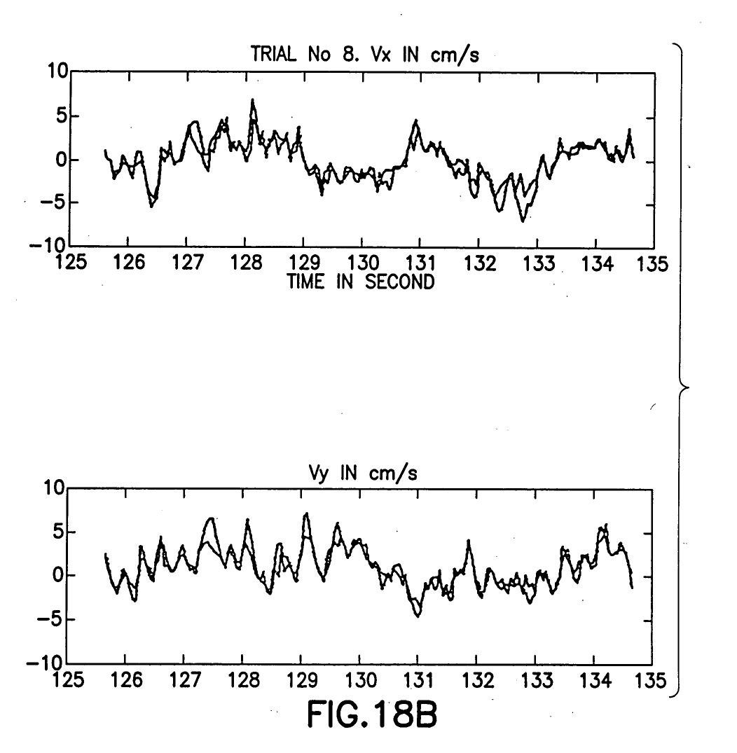

From the set of synthetic cells one may then generate a synthetic spike train by taking a known sequence of hand velocities and stochastically generating spikes using the learned conditional firing models with a Poisson generative model. Particle filtering is used to estimate the posterior distribution over the hand velocities given the synthetic neural data. The expected value of the horizontal and vertical velocity is shown in FIG. 18A. For comparison, a standard linear filtering method was trained on the synthetic data from 50 ms intervals. The resulting prediction is shown in FIG. 18B. As should be apparent, linear filtering works well over longer time windows that introduce lag, while the Bayesian analysis, in accordance with this aspect of the invention, provides a probabilistic framework for sound causal estimates over short time intervals (e.g., of about 50 ms to 70 ms, or less).

This second aspect of the invention has been described in the context of a Bayesian model for neural activity in MI that relates neural activity to actions that occur in #D space. Quantitative comparison with previous models of MI activity indicate that the non-parametric models computed using regularization more accurately describe the neuronal activity. In particular, the robust spatial prior term suggests that neural firing in MI is not a smooth function of velocity, but rather exhibits discontinuities between regions of high and low activity.

Also described has been the Bayesian decoding of hand motion from firing activity using a particle filter. Results suggest that measurements from at least several hundred cells may be required for accurate estimates of hand velocity. The application of particle filtering to this problem has many advantages, as it allows the use of complex, non-Gaussian, likelihood models that may incorporate non-linear temporal properties of neural firing (e.g. refractory period). Unlike conventional linear filtering methods, the Bayesian approach provides probabilistically sound, causal, estimates in short time windows of 50 ms.

Based on the foregoing discussion it should be apparent that the inventors have developed a method and apparatus for recording brain signals and translating the recorded brain signals into a “movement signal” that can be used to control devices, such as computers and machines, such as prosthetics and robot manipulators.

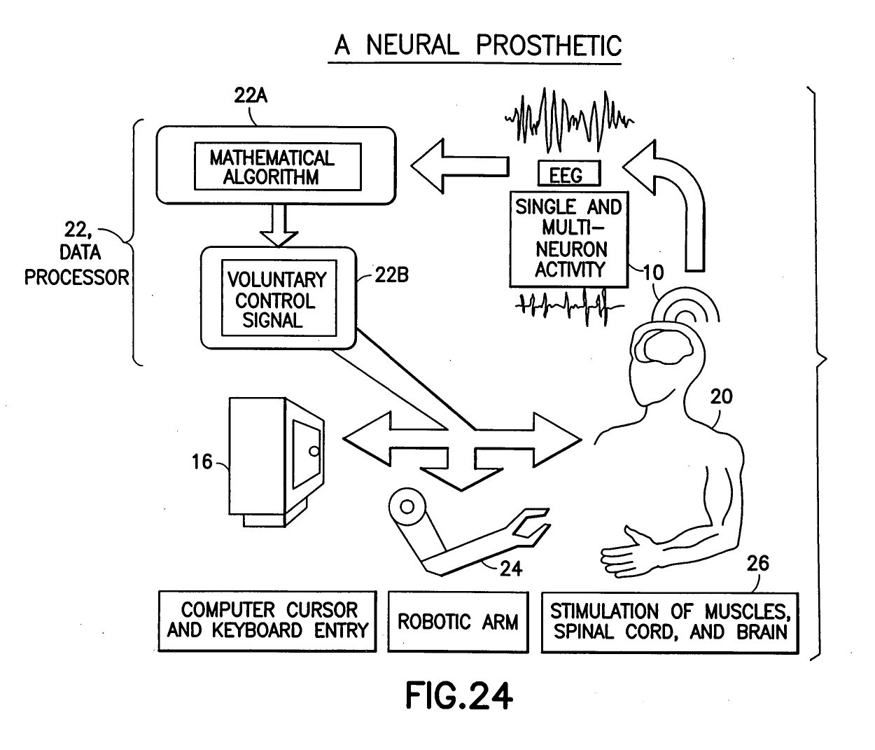

Reference in this regard can be made to FIG. 24, where neural electrical activity of a subject 20 is monitored, such as with the multi-electrode array 10 or by some other suitable means, to provide an EEG signal that is processed by a data processor 22 that operates in accordance with a mathematical algorithm 22A based on one of those discussed above. The data processor contains or controls circuitry 22B to generate a voluntary control signal based on the processing of the EEG signal from the subject 20. The voluntary control signal 22B can be used as a feedback signal to the monitor 16, and/or to a robotic arm of manipulator 24, and/or to a device 26 that provides direct stimulation of the subject 20, such as muscle, spinal cord and/or brain stimulation.

The apparatus described above is thus comprised of several parts: (a) a measurement system that records signals from the brain (either implanted or external); (b) an encoding system that stores a model of neural activity in the brain and how it is related to the control signal; (c) a decoding system that uses the encoding system and signals from the measurement system to translate brain signals into control signals; and (d) an interface system that connects the control signal to different devices. The described embodiments are more accurate than previous approaches based on linear filtering.

Important elements of this invention include, but are not necessarily limited to, the use of separate measurement and system models, and the modeling of the covariance of the cell firing properties.

The measurement system should be understood to encompass any system that measures information about brain activity at an instant in time, or over a continuous sequence of times. For example, suitable and non-limiting measurement technologies include MRI, EEG, MEG, optical imaging, near-infra red imaging, and various electrode recording techniques. Thus, while the invention has been described in the context of the microelectrode array 10, other suitable measurement devices and systems can be employed. Furthermore, recordings could be made from many parts of the brain. Thus, while the arm area of motor cortex was discussed above because it naturally represents and controls movement, other brain areas could also be selected.

The prior art on encoding and decoding views the problem as follows. The goal is to recover a movement signal x(t) from brain activity z(t) at time t. The movement signal is treated as a function of z(t): x(t)=F(z(t)), where F( ) is either a linear filter, an artificial neural network, or other statistical model. This can be referred to as a single part model.

In contrast to the single part model, described herein is an encoding model with two parts: a measurement part and a system part. The measurement part models the relationship between firing and the movement signal, while the system part models how the movement signal changes over time. In a general form, the measurement model represents: p(z|x). This is the “likelihood” of observing the neural firing z conditioned on the movement signal x. This could be at a particular time instant p(z(t)|x(t)), or it could involve multiple time instants.

This invention also pertains to a Linear Gaussian model, i.e., a measurement model where p(z|x) is represented by:

z(t)=H(t)×(t)+noise(t),

where H(t) is a matrix, x(t) is a vector comprising the movement signal, z(t) is a vector of measurements from the brain, and noise(t) is some additive noise term. The term z(t) may be a vector of firing rates for some number n of neurons. In the preferred embodiment these are the firing rates of cells recorded in the arm area of the primary motor cortex.

Neuron firing rates (or spike counts) are computed in non-overlapping time bins of, for example, 50 ms or 70 ms. It should be understood, however, that the time bins could be overlapping, and that they can be of different durations. The rate may be estimated in different ways.

H(t) may be a matrix of linear coefficients. In the preferred embodiment H(t)=H; that is H does not change over time, but it should be understood that it could.

The term x(t) is a vector containing the kinematics of the control signal. In the preferred embodiment x(t) includes position, velocity, and acceleration. It is understood that x(t) could contain different kinematic parameters (e.g. just position, just velocity, or more terms including jerk or higher order kinematic variables). It could also contain angles, mass, inertia or other dynamical properties. The term x(t) could be expressed in polar coordinates. It should also be understood that x(t) could be 2D or 3D position. It could also comprise any other parameters relevant to a control task. It could, for example, represent the six degrees of freedom necessary to control the end effector of a robot arm (i.e., 3D position and rotation).

The noise(t) is from a Gaussian (normal) distribution. That is, noise(t)˜N(H(t)x(t), Q(t)), where H(t)x(t) is the mean of the distribution and Q(t) is a covariance matrix. Q(t) could be a full or diagonal matrix. In the preferred but non-limiting embodiment Q(t)=Q is fixed over time and is a full covariance matrix.

Also disclosed is a method for learning the above-described parameters from training data. For example, a paralyzed patient can be presented with different visual displays showing a moving cursor. The cursor motion will vary in different ways in different displays. For example, in one display the cursor varies in x-position or y-position, while in another the cursor varies in velocity. In practice, each display varies some key element (or small number of elements) of the model that is being trained. Specifically, this variation can be periodic (though this is not required). The patient is instructed to imagine tracking the cursor with their hand. The apparatus and method then detect the periodicity in the neural signals that matches the periodicity in the visual data to align the data. The matrices H and Q can be updated so that the recovered trajectory minimizes the difference to the true trajectory. This optimization can be performed in a variety of ways (for example, a gradient descent technique can be used). As new training data is acquired these matrices continue to adapt to incorporate the new measurements. The Kalman filter algorithm can be exploited for this task.

In a Generalized Linear Model the noise is not Gaussian. In the preferred embodiment a Poisson with log link function can be used. Other link functions, e.g., a truncated identity link function, can also be employed:

f(x)=x, when xepsilon( )=epsilon*exp(x/epsilon−1), when x<epsilon.

Another embodiment combines nonparametric models of position and velocity (or other variables) together:

log(mu)=b0+b1*f1(x,y)+b2*f2(vx,vy)

where f1( ) and f2( ) are before-hand fitted non-parametric models.

In a Generalized Additive Model a non-linear model is used with Gaussian or non-Gaussian noise. A preferred embodiment uses splines, and assumes independence. For example, one may model multi-dimensional splines and covariance. One dimensional splines may be used, as could 2D splines or other parameterized smoothing functions. A further embodiment combines nonparametric models of position and velocity (or other variables) together:

log(mu)=f1(x,y)+f2(vx,vy).

Also, an iterative backing fitting technique, together with a non-parametric model, can be used to fit f1( ) and f2( ). Any missing data can be handled by zero padding or linear imputation.

Non-parametric model regularization, and Principle Component Analysis (PCA) can be used to reveal the major components of non-parametric models across cells.

In accordance with a mixture model:

p(z|x)=sum_{—}i w_{—}i p_{—}i(z/x), where p_i(z|x)=N(H_i x, O_i).

The mixture model has a good ability to fit the density function. Full covariance describes the correlations between cells. All of the parameters in the model can be efficiently learned by an EM algorithm, and a small amount of data are enough for the learning process.

Suitable pre-processing techniques include the use of a plus-one-square-root transform to make firing rate more Gaussian; the centralization of firing rate and kinematics to fit the zero mean of the noise; and PCA of the firing rate measurements to reduce their dimensionality. This allows training models with less data, which can be important for paralyzed patients. A consideration has been made of lag, and one of the advantages of the technique is that one can introduce time lags between firing and activity: p(z(t−j)|x(t)). A greedy algorithm can be used for learning non-uniform lags.

The System Model: p(x(t)|x(t−1),x(t−2). . . x(0)) models how the system evolves. By making it explicit one can enforce smoothness, physical properties such as inertia, or “priors” that constrain the range of possible values taken on by x(t).

In a Linear Gaussian model the first order Markov assumption is given by:

x(t)=A(t)x(t−1)+noise(t).

As above, x(t)˜N(A(t) x(t−1), W(t)), where W(t) is a covariance matrix.

In a non-linear model, x(t)=F(X(t−1))+noise.

With regard to decoding, a method is disclosed for taking a system model and a measurement model to produce a control signal. This model Bayesian inference:

p(x(t)|Z(t))=k p(z(t)|x(t)) Integral p(x(t)|x(t−1))p(x(t−1)|Z(t−1))d t−1

There are a number of ways to perform the decoding. With the Linear Gaussian model, the preferred embodiment is the Kalman filter. In a Linear, but non-Gaussian, model, one may exploit a Switching Kalman filter or a mixture of Kalman filters.

SKF is a real-time decoding algorithm for the mixture model. It has an efficiency close to that of the Kalman filter. It is deterministic (avoiding the sampling variations in Monte Carlo methods, e.g., in the particle filter).

In the non-linear Gaussian model the preferred approach uses an Extended Kalman filter, while in a non-linear, non-Gaussian model the particle filter is preferred.

The encoding model may be updated over time. For example, updating Q(t) can be performed using an ad hoc model based on the magnitude of firing rates. One can also use the Kalman filter model to learn H(t) and A(t).

With regard to interfaces, the above encoding/decoding models address estimation in a discretized version of continuous time. As opposed to smooth trajectories, one may use the same models to deal with discrete states of the brain. In this case the model becomes a Hidden Markov Model (HMM), and there are well-known algorithms for learning the model and performing inference.

Thus, while this invention has been described in the context of presently preferred embodiments, those skilled in the art should appreciate that the disclosed embodiments are not to be construed as being limitations upon the scope and practice of this invention.

What is claimed is:

1. An encoding model of neuron activity comprising:
a measurement component for modeling the relationship between the firing of a population of neurons and a movement signal; and
a system component for modeling how the movement signal changes over time.

2. An encoding model as in claim 1, where the measurement component represents: p(z|x), which is a likelihood of observing the neural firing z conditioned on the movement signal x, at one or more time instants.

3. A method to decode neural activity in the motor cortex to infer at least the position and velocity of a subject's hand from neural spiking activity of some number of nerve cells, comprising:
simultaneously recording electrical activity of the nerve cells in the primary motor cortex to obtain neural data; and
modeling the encoding and decoding of the neural data using a Kalman filter, where a measurement model assumes a cell firing rate to be a stochastic linear function of at least the position and velocity of the hand, and where the measurement model is learned from training data in conjunction with a system model that encodes a manner in which the hand moves.

4. A method as in claim 3, where the Kalman filter is used to obtain an optimal temporal lag time between hand movement and neuron firing.

5. A system to decode neural activity in the motor cortex to infer at least the position and velocity of a subject's hand from neural spiking activity of some number of nerve cells, comprising:
means for simultaneously recording electrical activity of the nerve cells in the primary motor cortex to obtain neural data; and
means for modeling the encoding and decoding of the neural data using a Kalman filter, where a measurement model assumes a cell firing rate to be a stochastic linear function of at least the position and velocity of the hand, and where the measurement model is learned from training data in conjunction with a system model that encodes a manner in which the hand moves.

6. A system as in claim 5, where the Kalman filter is used to obtain an optimal temporal lag time between hand movement and neuron firing.

7. A method to decode neural activity in the motor cortex to infer at least the position and velocity of a subject's hand from neural spiking activity of some number of nerve cells, comprising:
simultaneously recording electrical activity of the nerve cells in the primary motor cortex to obtain neural data;
using the neural data to generate training data of neural firing activity conditioned on hand kinematics;
learning a non-parametric representation of the firing activity using a Bayesian model;
inferring an a posterior probability distribution over hand motion, conditioned on the neural training data using Bayesian inference; and
defining a non-Gaussian likelihood term that is combined with a prior probability for the kinematics based on learned firing models of multiple nerve cells.

8. A method as in claim 7, further comprising using a particle filtering method to represent, update, and propagate the posterior distribution over time.

9. A system to decode neural activity in the motor cortex to infer at least the position and velocity of a subject's hand from neural spiking activity of some number of nerve cells, comprising:
means for simultaneously recording electrical activity of the nerve cells in the primary motor cortex to obtain neural data; and
means for using the neural data to generate training data of neural firing activity conditioned on hand kinematics; for learning a non-parametric representation of the firing activity using a Bayesian model; for inferring an a posterior probability distribution over hand motion, conditioned on the neural training data using Bayesian inference; and for defining a non-Gaussian likelihood term that is combined with a prior probability for the kinematics based on learned firing models of multiple nerve cells.

10. A system as in claim 9, further comprising a particle filter to represent, update, and propagate the posterior distribution over time.
